(19) United States
(12) Patent Application Publication
(10) Pub. No.: US 2026/0070315 A1
(43) Pub. Date: Mar. 12, 2026

(54) VACUUM-INSULATED STRUCTURES EMPLOYING PLANT MATERIALS, AND METHODS FOR FABRICATION AND USE THEREOF

(71) Applicants: UNIVERSITY OF MARYLAND, COLLEGE PARK, College Park, MD (US); INVENTWOOD INC., College Park, MD (US); UNIVERSITY OF MASSACHUSETTS, Lowell, MA (US)

(72) Inventors: Jiaqi DAI, Washington, DC (US); Amy GONG, Woodbridge, CT (US); Liangbing HU, Woodbridge, CT (US); Xinpeng ZHAO, Berwyn Heights, MD (US); Jan KOSNY, Westborough, MA (US)

(21) Appl. No.: 19/102,366

(22) PCT Filed: Aug. 9, 2023
(86) PCT No.: PCT/US23/29863

§ 371 Date: Feb. 7, 2025

Related U.S. Application Data
(60) Provisional application No. 63/396,289, filed on Aug. 9, 2022.

(51) Int. Cl. B32B 27/06; B32B 7/12; B32B 27/08; B32B 27/32; B32B 27/36

(52) U.S. Cl. CPC B32B 27/065; B32B 7/12; B32B 27/08; B32B 27/32; B32B 27/36; B32B 2307/304; B32B 2317/18

(57) ABSTRACT

A vacuum-insulated structure can have one or more internal cells, one or more foam cores, and an enveloping structure. Each foam core can be formed from a plant material. Each foam core can be disposed within a respective one of the cells. The enveloping structure can seal each foam core within the respective cell at a pressure less than atmospheric pressure.

### CROSS-REFERENCE TO RELATED APPLICATIONS

The present application claims the benefit of U.S. Provisional Application No. 63/396,289, filed Aug. 9, 2022, entitled “Vacuum Insulated Structures Employing Plant Materials, and Methods for Fabrication and Use Thereof,” which is hereby incorporated by reference herein in its entirety.

### STATEMENT REGARDING FEDERALLY SPONSORED RESEARCH

This invention was made with government support under DE-EE0009702 awarded by the Department of Energy (DOE). The government has certain rights in the invention.

### FIELD

The present disclosure relates generally to insulating materials, and more particularly, to vacuum-insulated structures employing one or more foam cores formed from a plant material, such as, but not limited to, wood or bamboo.

### BACKGROUND

Vacuum-insulated panels (also referred to herein as vacuum insulation panels or VIPs) are regarded as one of the most promising solutions for providing high-performance thermal insulation. VIPs have been successfully utilized for some applications such as freezers and thermal packaging. In recent years, VIPs have increasingly been used in building applications, where one of the main driving forces is an increased focus on green building (e.g., passive houses, zero energy buildings, and/or zero emission buildings). Conventional VIPs have a porous core (e.g., fumed silica, aerogels, etc.) enveloped by an air-tight and vapor-tight barrier (e.g., aluminum and polyester films) that is heat sealed. The core has an open pore structure to allow all the air to evacuate, thereby creating a vacuum. The envelope needs to be air and vapor tight for the panel to up-hold its thermally insulating properties over time.

The insulation performance of VIPs typically ranges from R10 to R50. However, conventional VIPs require a completely open-porous core structure and low gas pressures (10⁻³-10⁻⁴ bar) to achieve targeted thermal resistance. The open structure can result in quick vacuum loss of the entire panel with even small punctures, as well as being difficult to cut to size, for example, for adjustment onsite. In addition, conventional VIPs are also expensive ($10-12/ft²), limiting their applications. As a potential substitute for conventional silica cores in VIPs, cellulose-based insulation materials (e.g., wood waste-based foam) have many advantages, including low costs and environmental impact over their life cycle. However, in order to maintain the porous structure and mechanical strength, current wood waste-based foam may contain up to 40% of binding agents, which increases structural thermal conductivity (>50 mW/(m·K)), density (>0.05 g/cm³), and material costs. Therefore, current state-of-the-art wood-based foams cannot meet the material performance requirements for VIP cores.

Embodiments of the disclosed subject matter may address one or more of the above-noted problems and disadvantages, among other things.

### SUMMARY

Embodiments of the disclosed subject matter system provide low-cost, sustainable, thermally-insulating vacuum-insulated structures (e.g., vacuum insulated panel (VIP) having an R-value ≥15). In some embodiments, the vacuum-insulated structure can be cuttable without a significant insulation loss (e.g., decrease to R-value of ˜13.5 and/or retaining ≥80% of insulative properties). In some embodiments, the vacuum-insulated structure has an array of multiple cells, each filled with an individual, evacuated foam core formed from a native plant material (e.g., wood, bamboo, etc.). Alternatively or additionally, in some embodiments, each foam core can be formed of blends of different types of fiber materials (e.g., plant and/or non-plant materials) and/or blends of different sized powders (e.g., meso-sized powders and nanosized powders).

In some embodiments, the plant material has been at least partially delignified, so as to increase a porosity thereof (e.g., having a porosity of 90-99%, inclusive). For example, a foam core (e.g., having a thermal conductivity of <45 mW/(m·K) and a density of <0.15 g/cm³) can be prepared by mixing binders with delignified wood chips and subsequently drying (e.g., freeze-drying, critical point drying, solvent exchange, etc.). In some embodiments, the delignification can expose more chemical bonds of the plant material, which exposed bonds may more readily attach to the binder (e.g., binder content of ˜10 wt %).

Alternatively or additionally, in some embodiments, the plant material can be mechanically or chemically split (e.g., blending, grinding, or otherwise fibrillating) into smaller-sized structures (e.g., chips, dust, powder, fibers, and/or fibrils), combined with surfactant (e.g., sodium dodecyl sulfate (SDS)), and subsequently dried (e.g., via oven drying) to form a foam. Alternatively or additionally, in some embodiments, plant material fibers (e.g., having a length in a first size range) can be combined with other fibers (e.g., having a length in a second size range, greater than the first size range) and exposed to an elevated temperature and/or pressure (e.g., via a hot press) to form a foam. In some embodiments, the other fibers can be thermoplastic or organic fibers, and the exposing to an elevated temperature and/or pressure can at least partially melt the other fibers.

In one or more embodiments, a vacuum-insulated structure can comprise one or more internal cells, one or more foam cores, and an enveloping structure. Each foam core can comprise a plant material. Each foam core can be disposed within a respective one of the one or more cells. The enveloping structure can seal each foam core within the respective cell at a pressure less than atmospheric pressure.

In one or more embodiments, a method can comprise providing one or more foam cores in one or more cells. Each foam core can comprise a plant material. Each foam core can be disposed within a respective one of the one or more cells. The method can further comprise sealing an enveloping structure under vacuum to form a vacuum-insulated structure and such that each foam core within the respective cell is sealed at a pressure less than atmospheric pressure.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIGS. 1A-1B are simplified plan and cross-sectional view, respectively, of a vacuum-insulated structure having a core formed of a plant material, according to one or more embodiments of the disclosed subject matter.

FIG. 1C is a simplified cross-sectional view of a vacuum-insulated structure having a core formed of a plant material and a closed-cell foam frame, according to one or more embodiments of the disclosed subject matter.

FIG. 1D is a simplified cross-sectional view of a vacuum-insulated structure having a core formed of a plant material and a pair of structural support layers, according to one or more embodiments of the disclosed subject matter.

FIG. 1E is a simplified cross-sectional view of another vacuum-insulated structure having a core formed of a plant material and a pair of structural support layers, according to one or more embodiments of the disclosed subject matter.

FIG. 2A is a simplified plan view of a vacuum-insulated structure with a hexagonal array of plant material cores, according to one or more embodiments of the disclosed subject matter.

FIGS. 2B-2C are simplified plan views of vacuum-insulated structures with hexagonal arrays of different cores sizes subjected to cutting, according to one or more embodiments of the disclosed subject matter.

FIG. 2D is a simplified plan view of a vacuum-insulated structure having regions of different core sizes, according to one or more embodiments of the disclosed subject matter.

FIG. 2E is a simplified plan view of a vacuum-insulated structure with a rectangular array of plant material cores, before and after cutting, according to one or more embodiments of the disclosed subject matter.

FIG. 2F is a simplified cross-sectional view of a vacuum-insulated structure employing a closed-cell foam in a cutting region.

FIG. 3A illustrates aspects of fabrication of a foam core from a plant material and binder, according to one or more embodiments of the disclosed subject matter.

FIG. 3B illustrates aspects of fabrication of a foam core from a plant material and surfactant, according to one or more embodiments of the disclosed subject matter.

FIG. 3C illustrates aspects of fabrication of a foam core from a plant material and other fibers, according to one or more embodiments of the disclosed subject matter.

FIG. 4A is a process flow diagram for fabricating a vacuum-insulated structure with plant-based foam core, according to one or more embodiments of the disclosed subject matter.

FIG. 4B is a process flow diagram for fabricating a foam core for use in a vacuum-insulated structure by drying a foam precursor, according to one or more embodiments of the disclosed subject matter.

FIG. 4C is a process flow diagram for fabricating a foam core for use in a vacuum-insulated structure by heating and/or pressing a foam precursor, according to one or more embodiments of the disclosed subject matter.

FIG. 5A is a simplified schematic diagram illustrating formation of a vacuum-insulated panel, according to one or more embodiments of the disclosed subject matter.

FIG. 5B is a simplified schematic diagram of a manufacturing setup for fabricating vacuum-insulated panels, according to one or more embodiments of the disclosed subject matter.

FIG. 6A shows scanning electron microscopy (SEM) images of a delignified wood chip for use in a foam core of a vacuum-insulated structure, according to one or more embodiments of the disclosed subject matter.

FIG. 6B is an image of a foam core fabricated from delignified wood chips, according to one or more embodiments of the disclosed subject matter.

FIG. 6C is a graph of compressive stress versus strain of a foam core fabricated from delignified wood chips.

FIG. 6D is an image of foam cores fabricated from delignified wood chips and having various non-planar geometries for use in a vacuum-insulated structure, according to one or more embodiments of the disclosed subject matter.

FIG. 6E is an image of a hexagonal array partially filled with foam cores fabricated from delignified wood chips for use in a vacuum-insulated structure, according to one or more embodiments of the disclosed subject matter.

FIGS. 7A-7C are graphs of thermal conductivity of wood pulp-polyester hybrid foams formed via a thermal bonding process at 0.01 MPa pressure, 0.005 MPa pressure, and no pressure, respectively.

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about,” “substantially,” or “approximately” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following are provided to facilitate the description of various aspects of the disclosed subject matter and to guide those skilled in the art in the practice of the disclosed subject matter.

Plant Material: A portion (e.g., a cut portion, via mechanical means or otherwise) of any photosynthetic eukaryote of the kingdom Plantae in its native state as grown. In some embodiments, the plant material comprises wood (e.g., hardwood or softwood), bamboo (e.g., any of Bambusoideae, such as but not limited to Moso, Phyllostachys vivax, Phyllostachys viridis, Phyllostachys bambusoides, and Phyllostachys nigra), reed (e.g., any of common reed (Phragmites australis), giant reed (Arundo donax), Burma reed (Neyraudia reynaudiana), reed canary-grass (Phalaris arundinacea), reed sweet-grass (Glyceria maxima), small-reed (Calamagrostis species), paper reed (Cyperus papyrus), bur-reed (Sparganium species), reed-mace (Typha species), cape thatching reed (Elegia tectorum), and thatching reed (Thamnochortus insignis)), or grass (e.g., a species selected from the Poales order or the Poaceae family). For example, the natural wood can be any type of hardwood (e.g., having a native lignin content in a range of 18-25 wt %) or softwood (e.g., having a native lignin content in a range of 25-35 wt %), such as, but not limited to, basswood, oak, poplar, ash, alder, aspen, balsa wood, beech, birch, cherry, butternut, chestnut, cocobolo, elm, hickory, maple, oak, padauk, plum, walnut, willow, yellow poplar, bald cypress, cedar, cypress, douglas fir, fir, hemlock, larch, pine, redwood, spruce, tamarack, juniper, and yew. Alternatively, in some embodiments, the plant material can be any type of fibrous plant composed of lignin, hemicellulose, and cellulose. For example, the plant material can be bagasse (e.g., formed from processed remains of sugarcane or sorghum stalks) or straw (e.g., formed from processed remains of cereal plants, such as rice, wheat, millet, or maize).

Lignin-compromised plant material: Plant material that has been modified by one or more chemical treatments to (a) in situ modify the native lignin therein, (b) partially remove the native lignin therein (i.e., partial delignification), or (c) fully remove the native lignin therein (i.e., full delignification). In some embodiments, the lignin-compromised plant material can substantially retain the native microstructure of the natural plant material formed by cellulose-based cell walls.

Partial Delignification: The removal of some (e.g., at least 1%) but not all (e.g., less than or equal 90%) of native lignin (e.g., on a weight percent basis) from the naturally-occurring plant material. In some embodiments, the partial delignification can be performed by subjecting the natural plant material to one or more chemical treatments. In some embodiments, the lignin content after partial delignification can be in a range of 0.9-23.8 wt % for hardwood or in a range of 1.25-33.25 wt % for softwood. Lignin content within the plant material before and after the partial delignification can be assessed using known techniques in the art, for example, Laboratory Analytical Procedure (LAP) TP-510-42618 for “Determination of Structural Carbohydrates and Lignin in Biomass,” Version Aug. 3, 2012, published by National Renewable Energy Laboratory (NREL), and ASTM E1758-01(2020) for “Standard Test Method for Determination of Carbohydrates in Biomass by High Performance Liquid Chromatography,” published by ASTM International, both of which are incorporated herein by reference. In some embodiments, the partial delignification process can be, for example, as described in U.S. Publication No. 2020/0223091, published Jul. 16, 2020 and entitled “Strong and Tough Structural Wood Materials, and Methods for Fabricating and Use Thereof,” and U.S. Publication No. 2022/0412002, published Dec. 29, 2022 and entitled “Bamboo Structures, and Methods for Fabrication and Use Thereof,” which delignification and densification processes are incorporated herein by reference.

Full Delignification: The removal of substantially all (e.g., 90-100%) of native lignin from the naturally-occurring plant material. In some embodiments, the full delignification can be performed by subjecting the natural plant material to one or more chemical treatments. Lignin content within the plant material before and after the full delignification can be assessed using the same or similar techniques as those noted above for partial delignification. In some embodiments, the full delignification process can be, for example, as described in U.S. Publication No. 20200238565, published Jul. 30, 2020 and entitled “Delignified Wood Materials, and Methods for Fabricating and Use Thereof,” which delignification processes are incorporated herein by reference.

Lignin modification: In situ altering one or more properties of native lignin in the naturally-occurring plant material, without removing the altered lignin from the plant material. In some embodiments, the lignin content of the plant material prior to and after the in situ modification can be substantially the same, for example, such that the in situ modified plant material retains at least 95% (e.g., removing no more than 1%, or no more than 0.5%, of the native lignin content) of the native lignin content. In some embodiments, the plant material can be in situ modified (e.g., by chemical reaction with OH⁻) to depolymerize lignin, with the depolymerized lignin being retained within the plant material microstructure. The lignin content within the plant material before and after lignin modification can be assessed using known techniques in the art, for example, Laboratory Analytical Procedure (LAP) TP-510-42618 for “Determination of Structural Carbohydrates and Lignin in Biomass,” Version Aug. 3, 2012, published by National Renewable Energy Laboratory (NREL), ASTM E1758-01(2020) for “Standard Test Method for Determination of Carbohydrates in Biomass by High Performance Liquid Chromatography,” published by ASTM International, and/or Technical Association of Pulp and Paper Industry (TAPPI), Standard T 222-om-83, “Standard Test Method for Acid-Insoluble Lignin in Wood,” all of which are incorporated herein by reference. In some embodiments, the lignin modification process can be, for example, as described in International Publication No. WO 2023/028356, published Mar. 2, 2023 and entitled “Waste-free Processing for Lignin Modification of Fibrous Plant Materials, and Lignin-modified Fibrous Plant Materials,” which lignin modification processes are incorporated herein by reference.

Microfibrillated Cellulose (MFC): A network of microfibrils formed by subjecting cellulose fibers to longitudinal fibrillation. In some embodiments, the MFC has a higher surface area than the starting cellulose fibers or cellulose powders. In the some embodiments, the microfibrils in the MFC can have a diameter on the order of nanometers (e.g., ≤100 nm) and a length on the order of microns (e.g., 1-1000 μm, inclusive).

Foam: A material formed by trapping pockets of gas in a liquid or solid. In some embodiments, the trapped gas is removed after forming, such that the resulting solid material has a high porosity. In some embodiments, the foam comprises a plant material, such as plant material chips, dust, powder, and/or fibers. In some embodiments, the plant material in the foam is lignin-compromised. In some embodiments, the foam can be a closed-cell foam, e.g., with no open channels (or minimal number of open channels) between enclosed pockets within the foam. In some embodiments, the closed-cell foam comprises extruded polystyrene (XPS).

Nanoparticle: A particle having a maximum cross-sectional dimension less than 1 μm, for example, in a range of 1 nm to 100 nm, inclusive.

Plant Material Dust or Powder: A plurality of plant material particles, each particle having a maximum cross-sectional dimension less than 1 mm, for example, in a range of 0.5 μm to 100 μm, inclusive.

Chip: A piece of plant material having a maximum cross-sectional dimension less than or equal to 5 cm, for example, in a range of 1 mm to 15 mm, inclusive.

Pulp: A lignocellulosic fibrous material formed by chemically and/or mechanically separating cellulose fibers from a plant material. In some embodiments, fibers constituting the pulp have a length less than or equal to 1 cm.

### INTRODUCTION

Disclosed herein are vacuum-insulated structures having one or more foam cores formed from natural plant material. In some embodiments, the plant material can be at least partially delignified (e.g., at least 5% of native lignin removed, for example, at least 10% of native lignin removed). For example, the controlled delignification process can create additional nanopores into the already mesoporous plant material chips, which can drastically improve the insulation performance of the plant material for use as a low-cost high-performance foam core. Alternatively or additionally, in some embodiments, lignin with the plant material can be modified, for example, to have shorter macromolecular chains than that of the native lignin, such that the plant material is softened and/or has increased porosity.

In some embodiments, the plant material can be the main constituent of the foam core, for example, with a content of binder, surfactant, inorganic nanoparticles, or non-plant fibers (e.g., thermoplastic or organic fibers) therein being less than 20 wt % of the foam. Alternatively or additionally, in some embodiments, the plant material (with or without delignification) can act as a scaffold, for example, to support another porous material within a cell of the vacuum-insulated structure. For example, silica aerogel can be mixed with the plant material and/or infiltrated (e.g., vacuum-infiltrated) into the plant material.

In some embodiments, plant material (e.g., in the form of chips, dust, pulp, and/or fibers) can be mixed with a binder (e.g., polymer binder, such as a bio-polymeric binder) and then subsequently dried to form a homogeneous porous foam. For example, the drying can be freeze-drying (e.g., a temperature ≤−20° C., for example, about −80° C.; pressure ≤10 Pa, for example, about 0.7-1 Pa), critical point drying (e.g., using liquid carbon dioxide), and/or solvent exchange (e.g., exchanging water with an alcohol). Alternatively or additionally, in some embodiments, plant material (e.g., in the form of dust, pulp, and/or fibers) can be mixed with a surfactant (e.g., an anionic surfactant, such as SDS) and then subsequently dried to form a homogeneous porous foam. For example, the drying can be via heating (e.g., a temperature in a range of 50-100° C., such as about 70° C.; a time in a range of 2-24 hours, such as about 12-16 hours) in an oven. The surfactant can introduce air bubbles into the plant material matrix, which can resist structural collapse during the subsequent oven-drying.

Alternatively or additionally, in some embodiments, the plant material foam can be formed without drying (e.g., without needing to remove water or other solvent). In some embodiments, the plant material (e.g., in the form of first fibers) can be combined with other fibers (e.g., in the form of second fibers), which can serve as a support matrix and/or binder, for example, after thermal bonding. In some embodiments, the combination of the plant material and other fibers can be subjected to an elevated temperature (e.g., in range of 150° C. to 250° C.) and/or an elevated pressure (e.g., in a range of 2 kPa to 1 MPa) for a time (e.g., ≤10 minutes) to form a porous foam without involving any water. In some embodiments, the other fibers can have a size (e.g., length and/or diameter) greater than that of the plant material fibers. For example, the other fibers can be plastic fibers (e.g., a recycled plastic, such as polyester) having a long length (e.g., ≥1 cm), and/or the plant material can be in the form of fibers having a short length (e.g., ≤1 cm).

In some embodiments, the vacuum-insulated structure is formed as a panel having a cost of ≤$1/ft²-in and an overall panel insulation of R15 (e.g., 10 mW/m·K). In some embodiments, the vacuum-insulated structure can be constructed to be cut to size (e.g., onsite) without sacrificing significant insulation performance. In some embodiments, the vacuum-insulated structure can have a plurality of vacuum-sealed cells, each with its own foam core. The vacuum-cell-array structure can confine the vacuum loss to only a few cells around the cuts, which can minimize, or at least reduce, edge losses. In addition, the vacuum-cell-array structure can enable onsite cutting and/or puncturing without sacrificing overall insulation performance significantly. For example, the overall panel insulation can be at least R13.5 before/after cutting and can have an open edge insulation of at least R5 (e.g., 30 mW/m·K).

In some embodiments, providing a plurality of cells within the vacuum-insulated structure can act as a structural reinforcement, which can decouple the porosity and mechanical strength trade-offs of the core. This can enable the core to be highly porous and insulative while the cell arrays provide additional mechanical strength for enhanced robustness. In some embodiments, edges between adjacent vacuum-insulated structures can be joined, for example, through thermal sealing, patching, and/or gluing (e.g., for aluminum-laminated films), which can allow for re-sealing and vacuuming cut cells onsite to further retain the overall thermal performance.

Although the discussion herein primarily focuses on wood chips for the core, embodiments of the disclosed subject matter are not limited thereto. Rather, the teachings of the present disclosure can be readily extended to other plant materials (e.g., bamboo) and/or other initial plant material structures. Indeed, the teachings disclosed herein can be applicable to a variety of cellulose-based products including but not limited to pulp, plant material dust (e.g., sawdust), powder, and/or fibers. In some embodiments, low-value plant materials, such as small diameter trees and wood waste from forest management, can be used to form the foam cores. Alternatively or additionally, other plant materials (e.g., grass, bamboo, and bagasse) can be used.

Alternatively or additionally, in some embodiments, the foam core can comprise and/or be formed from other materials (e.g., non-plant materials). For example, the foam core can comprise glass fiber, fumed silica, open-cell polymer foam (e.g., polystyrene or polyurethane), glass foam, or any combination of the foregoing. In some embodiments, foam core(s) formed from and/or comprising non-plant materials can be combined with a frame formed from and/or comprising a plant material, for example, densified, lignin-compromised wood or bamboo. Alternatively, in some embodiments, a closed-cell foam can be used for the frame, and the foam core(s) can be formed from and/or comprise a non-plant material.

### Vacuum-Insulated Structures

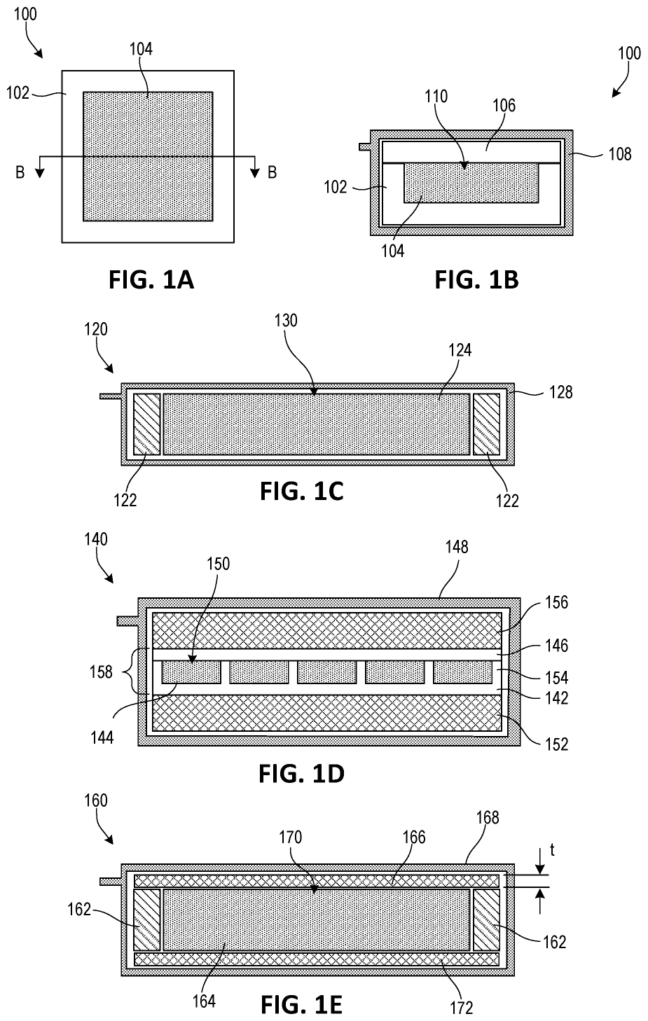

FIGS. 1A-1B show an exemplary vacuum-insulated structure 100 having a base layer 102, a foam core 104 formed from a plant material and loaded into internal cell 110, and a cap layer 106. In the illustrated example, the vacuum-insulated structure 100 further includes an enveloping structure 108 (e.g., an envelope film, for example, a film formed of a metal (e.g., aluminum) and/or polymer (e.g., polyethylene terephthalate, polyimide); however, in some embodiments, the base layer 102 and/or the cap layer 106, or portions thereof, can be considered an enveloping structure (e.g., without a separate structure enclosing the base and cap layers). For example, the base layer 102 and/or the cap layer 106 can be formed of or comprise a metal-polymer laminate, such as aluminum-polyester. In some embodiments, the base layer 102 can at least partially define the internal cell 110 (e.g., side and bottom walls thereof) filled by foam core 104. Alternatively or additionally, the base layer 102 and the cap layer 106 can cooperatively define the internal cell 110, for example, with the base layer defining a bottom wall and part of the side walls of the internal cell, and the cap layer defining a top wall and a remaining part of the side walls of the internal cell. In some embodiments, the enveloping structure 108 can be evacuated, for example, to seal the foam core 104 within the internal cell at a pressure less than atmospheric pressure (e.g., ≤100 Pa, such as ˜10 Pa). Alternatively or additionally, in some embodiments, the base and cap layers can be coupled together to seal the foam core 104 within the cell at the pressure less than atmospheric pressure.

In the illustrated example of FIGS. 1A-1B, the internal cell is defined by the opposing top and bottom support layers (e.g., base layer 102 and cap layer 106). Alternatively or additionally, in some embodiments, the internal cell can be defined, at least in part, by a frame separate from top and bottom support layers. For example, FIG. 1C shows an exemplary vacuum-insulated structure 120 having a frame 122 that bounds (e.g., defines side walls of) internal cell 130. A foam core 124 formed from a plant material can be disposed within the internal cell 130, and the frame 122 can surround the foam core 124 on each of its lateral sides. Enveloping structure 128 (e.g., an envelope film) can enclose the frame 122 and foam core 124 therein and can seal the foam core 104 within the internal cell 130 at a pressure less than atmospheric pressure. In the illustrated example, top and bottom surfaces of the foam core 124 are exposed from frame 122 and face respective portions of the enveloping structure 128. Alternatively, in some embodiments, a portion of the frame 122 may instead form a bottom wall and/or a top wall of the internal cell 130.

In some embodiments, the frame 122 can be formed of a material that improves the mechanical strength (e.g., rigidity) and/or the thermal insulating properties of the overall vacuum-insulated structure. In some embodiments, the frame 122 can be formed of or comprise a polymer, for example, a rigid closed-cell foam (e.g., extruded polystyrene, for example, having a thermal conductivity of ˜30 mW/(m·K)). In some embodiments, the closed-cell foam used for the frame 122 can be rigid and/or substantially gas impermeable. Alternatively or additionally, in some embodiments, the frame 122 can be formed of or comprise a densified, lignin-compromised plant material, for example, a densified, partially-delignified wood or bamboo (e.g., as disclosed in U.S. Publn. No. 2020/0223091 or U.S. Publn. No. 2022/0412002), or a densified, lignin-modified wood or bamboo (e.g., WO Publn. No. 2023/028356).

In some embodiments, the vacuum-insulated can be combined with other structural plant materials (e.g., wood, bamboo, etc.), for example, to enhance structural rigidity for use as a building material and/or to enhance thermal properties. For example, FIG. 1D shows a composite panel 140 comprising a vacuum-insulated structure 158 disposed between a front support layer 156 and a rear support layer 152. Similar to the example of FIGS. 1A-1B, the vacuum-insulated structure 158 can have a base layer 142 with vertically-protruding portions 154 that define sidewalls of an array of individual internal cells 150. A cap layer 146 can be disposed over the base layer 14 and can seal foam cores 144 within the respective internal cells 150. Front support layer 156 and/or rear support layer 152 can be an external panel formed of a plant material. In the illustrated example, the composite panel 140 further includes an enveloping structure 148 (e.g., an envelope film, for example, a film formed of a metal (e.g., aluminum) and/or polymer (e.g., polyethylene terephthalate, polyimide); however, in some embodiments, the front support layer 156 and/or the rear support layer 152, or portions thereof, can be considered an enveloping structure (e.g., without a separate structure enclosing the front and rear support layers).

In some embodiments, one or both layers 152, 156 can be formed as a high-strength densified wood or bamboo, for example, as described in U.S. Pat. No. 11,130,256, issued Sep. 28, 2021, entitled “Strong and Tough Structural Wood Materials, and Methods for Fabricating and Use Thereof,” and International Publication No. WO 2021/108576, published Jun. 3, 2021, entitled “Bamboo Structures, and Methods for Fabrication and Use Thereof,” each of which is incorporated herein by reference. In addition to or in place of support layers 152, 156, outer support layers can be formed on sides of vacuum-insulated structure 158, for example, such that all surfaces of the vacuum-insulated structure 158 are covered or protected by a respective outer support layer. Alternatively or additionally, one, some, or all of the outer support layers can be formed as or include a thermally-insulating or solar-reflective delignified wood or bamboo, for example, as described in U.S. Publication No. 2020/0238565, published Jul. 30, 2020, entitled “Delignified Wood Materials, and Methods for Fabricating and Use Thereof,” which is incorporated herein by reference.

In the illustrated example of FIG. 1D, the outer support layers 152, 156 sandwich therebetween base and cap layers 142, 146 that define internal cells 150. However, in some embodiments, the frame features of FIG. 1C can be combined with the outer support layers of FIG. 1D. For example, FIG. 1E shows a vacuum-insulated structure 160 comprising a front support layer 166, a rear support layer 172, and a frame 162 that bounds (e.g., that defines side walls of) internal cell 170. Similar to the configuration and construction of frame 122 in FIG. 1C, frame 162 can surround a foam core 164 that is formed from a plant material and disposed within internal cell 170. In the illustrated example, the vacuum-insulated structure further includes an enveloping structure 168 (e.g., an envelope film, for example, a film formed of a metal (e.g., aluminum) and/or polymer (e.g., polyethylene terephthalate, polyimide); however, in some embodiments, the front support layer 166 and/or the rear support layer 172, or portions thereof, can be considered an enveloping structure (e.g., without a separate structure enclosing the front and rear support layers).

Similar to the configuration and construction of outer support layers 152, 156 in FIG. 1D, one or both support layers 166, 172 can be formed as a high-strength densified wood or bamboo, for example, exhibiting a thermal conductivity less than 1 W/m·K (e.g., about 0.4 W/m·K). In some embodiments, one or both support layers may be thin, for example, having a thickness, t, less than or equal to 1 mm (e.g., in a range of 50-500 μm, inclusive). A thickness of the rear support layer 172 can be the same as or different from that of front support layer 166.

In conventional vacuum-insulated panels (VIPs), the thin film envelope typically used may be susceptible to puncture from sharp objects or mishandling (e.g., during installation or use). In contrast, the vacuum-insulated structure 160 in the illustrated example of FIG. 1E can have enhanced puncture resistance by virtue of the front and rear support layers 166, 172, which have high mechanical strength and low gas permeability, in combination with enveloping structure 168. In addition, thermal bridging effects (e.g., heat transfer between front and rear surfaces) of the vacuum-insulated structure 160 can be minimized, or at least reduced, by the use of a thermally-insulating material for frame 162, for example, a rigid closed-cell foam that can also provide structural support.

### Foam Core Arrays

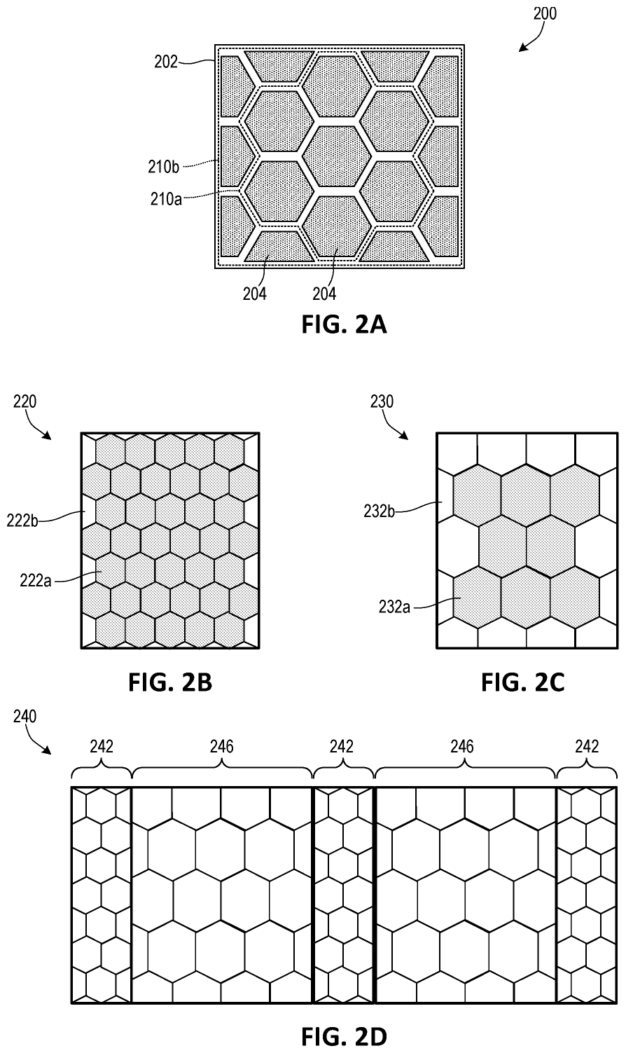

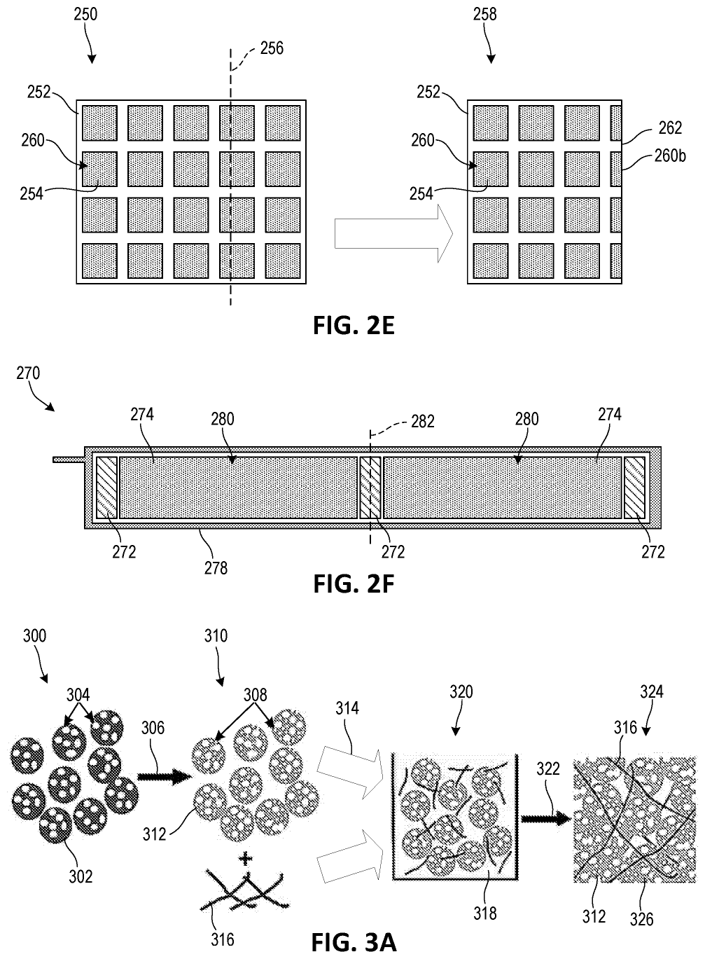

In FIGS. 1A-1C and 1E, the vacuum-insulated structure has a single foam core formed of a plant material. However, in some embodiments, for example, to prevent vacuum loss when a portion of the structure is compromised (e.g., cutting during installation or puncture of the envelope during installation or use), the vacuum-insulated structure can comprise a plurality of isolated internal cells (e.g., a hexagonal or honeycomb array, a rectangular array, etc.). In some embodiments, the foam-core-loaded cells can be substantially identical to each other in shape and/or size (e.g., having a maximum dimension in plan view of 2-10 cm). For example, FIG. 2A illustrates a vacuum-insulated structure 200 having a frame 202 (or protruding portions of a base layer) forming a plurality of substantially identical internal cells 204. Each cell 204 can have a respective foam core sealed therein.

In the illustrated example, the plurality of cells 204 can be segregated into two regions—a first region 210a of cells remote from the panel edge and a second region 210b of cells adjacent to the panel edge. In some embodiments, the second region 210b can result from cutting the vacuum-insulated structure 200 down to a desired size for installation or use. As a result of the cutting, the seal in cells 204 within region 210b may be compromised. However, because the frame 202 isolates the cells 204 within region 210a from the cells in region 210b, the insulating properties of the vacuum-insulated structure 200 can be retained, or at least improved, despite the cutting.

In some embodiments, the multiple isolated vacuum cells can permit cutting and/or puncturing of the panel without otherwise sacrificing overall insulation performance. The multi-cell panel structure can block radiative heat, as well as be sealed to maintain a vacuum. Since the vacuum-cell-array structure confines the vacuum loss to only a few cells around the cuts, edge losses can be minimized and onsite cutting and puncturing without sacrificing overall insulation performance is allowable. The size of each isolated vacuum cell can influence both the overall thermal insulation performance after cutting and the panel strength. Smaller cells 222a provide stronger reinforcement and a smaller cut-open edge area 222b, as shown for vacuum-insulated structure 220 of FIG. 2B. However, this may lead to increases in material costs and overall panel thermal conductivity (e.g., due to thermal bridging of cell walls between front and rear surfaces). Larger cells 232a have a larger cut-open edge area 232b, as shown for vacuum-insulated structure 230 of FIG. 2C, albeit with lower thermal conductivity. Alternatively or additionally, in some embodiments, some or all of the vacuum cells can have a different shape and/or different size. For example, cells in a predefined cut region 242 may be a smaller size than cells in a predefined insulation region 246 between cut regions, as shown for vacuum-insulated structure 240 in FIG. 2D.

Although a hexagonal array has been described above, embodiments of the disclosed subject matter are not limited thereto. Rather, in some embodiments, the cells within the vacuum-insulated structure can be formed as rectangles and/or in a rectangular array. For example, FIG. 2E illustrates a vacuum-insulated structure 250 having a frame 252 (or base layer) that defines and/or bounds an array of isolated rectangular cells 260, each of which is filled with a corresponding foam core 254 formed from plant material. Vacuum-insulated structure 250 can be cut to size, for example, along cut line 256, to fit a particular installation. Similar to operation of the hexagonal array, vacuum loss can be constrained to only cells 260b adjacent to edge 262 of the cut structure 258.

In the illustrated example of FIG. 2E, the cut line 256 extends through cells 260, such that the vacuum in the cells 260b adjacent to the edge 262 are compromised. However, in some embodiments, the frame can be formed of and/or comprise a substantially gas impermeable material, and the cut line (e.g., cut line 282 in FIG. 2F) can be limited to passing through the frame, such that the vacuum in all cores, including those adjacent to the cut edge, can be retained despite the cutting. For example, FIG. 2F illustrates a vacuum-insulated structure 270 having a frame 272 that defines and/or bounds internal cells 280, foam cores 274 formed from plant material in each internal cell 280, and an enveloping structure 278 surrounding the frame 272 and cores 280. In some embodiments, the frame 272 can be formed of or comprise a rigid closed-cell foam such as extruded polystyrene.

In contrast to a honeycomb structure that employs Al-laminated films, the vacuum-insulated structure 270 can offer ease of fabrication while mitigating the thermal bridging effect of the frame. The rigid closed-cell foam of frame 272 can serve as an effective structural material that maintains the vacuum in sealed cores 280 despite being adjacent to cut line 282, thereby allowing for precise customization and adjustments during installation by cutting the vacuum-insulated structure 270. In addition, the elimination, or at least reduction, of thermal bridging by using closed cell foam for or in the frame 272 can enhance the overall insulation performance.

Fabricating Foam Cores from Plant Materials

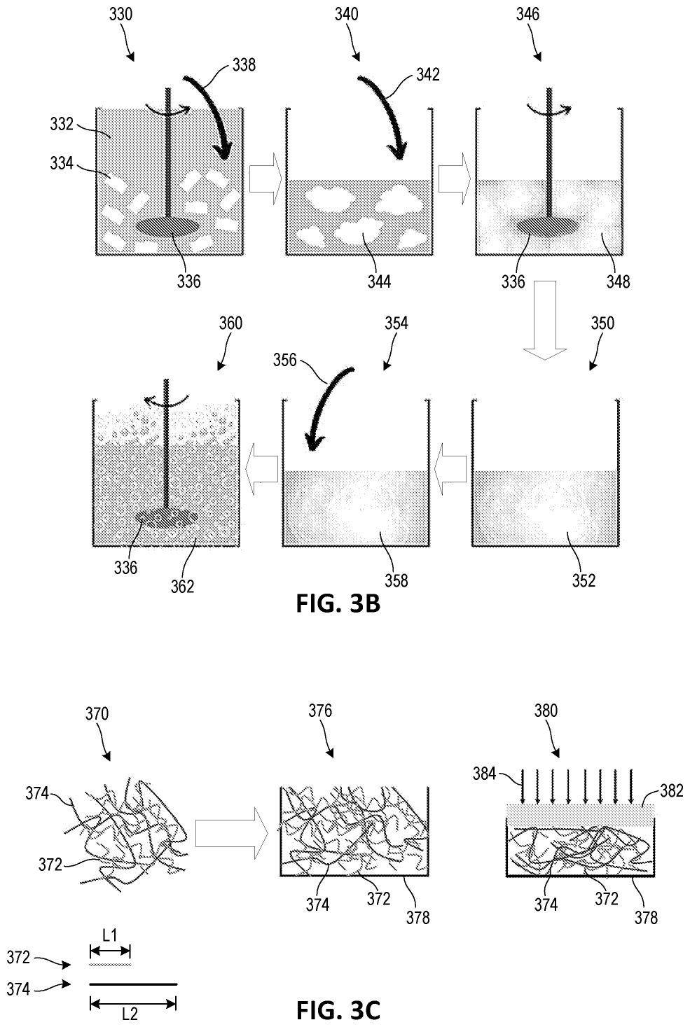

In some embodiments, a plant material can be subject to chemical delignification, for example, to introduce nanopores (e.g., having a maximum cross-sectional dimension ≤100 nm) into the already mesoporous plant material. The nanosized pores created through delignification or lignin modification can effectively suppress thermal transport in the air, reducing the cross-sectional area of the solid, as well as increasing the tortuosity of the heat transfer pathway. For example, in FIG. 3A, plant material chips 302 having micropores 304 (e.g., having a maximum cross-sectional dimension of 100 nm to 100 μm) are provided at an initial stage 300. The plant material chips 302 can be subjected to one or more chemical treatments 306 (e.g., immersion in one or more chemical solutions) that compromised the native lignin in the plant material. For example, in some embodiments, the chemical treatment(s) can be a partial delignification that removes at least 1% (e.g., ≥5% removal) but no more than 95% (e.g., ≤90% removal) of the native lignin in the plant material. Alternatively or additionally, in some embodiments, the chemical treatment(s) can be an in situ lignin modification that retains at least 95% of the native lignin in the plant material. At the post-chemical-treatment stage 310, the resulting lignin-compromised chips 308 can have nanopores 314 in addition to the pre-existing micropores 304.

In some embodiments, the chemical treatment 306 can be effective to increase a porosity of the plant material chips to greater than or equal to 90% (e.g., ˜90-99%). The lignin-compromised chips 312 can be mixed with one or more binders 316 (e.g., wood glue, epoxy, agar, 2-hydroxyethyl cellulose, carboxymethyl cellulose sodium salt) to form a foam precursor 318 at precursor stage 320. The foam precursor 318 can then be subjected to drying 322 to form a foam 326 at foam core stage 324. In some embodiments, the drying 322 can comprise freeze-drying, critical point drying, and/or solvent exchange.

In some embodiments, in addition to or in place of compromising lignin to introduce additional pores, a surfactant can be used to introduce air bubbles throughout the plant material that resist structural collapse during drying. In such embodiments, drying can be performed via heating in an oven to remove water from the foam precursor and form the plant material foam. For example, FIG. 3B illustrates aspects of forming a foam core from a plant material using surfactants. At pulp processing stage 330, pulp (e.g. ground white pulp board) can be added 338 to solution 332 to yield ground pulp pieces 334 in solution 332, which are then subjected to grinding by mixer 336 (e.g., blender blades). To the resulting pulp fluff 344, additional solution can be added 342 at stage 340. In some embodiments, the additional solution can include a slurry of microfibrillated cellulose (e.g., sold by FiberLean of Cornwall, UK). The combination can then be further mixed by mixer 336 (e.g., about 17900 rpm for 3 minutes) at blending stage 346 to yield a substantially uniform dispersion 348. The dispersion 348 can be allowed to sit for a period of time (e.g., about 12-24 hours) during a soaking stage 350, after which a surfactant is added 356 to mixture 352. After surfactant addition stage 354, the mixture with surfactant 358 can be mixed by mixer 336 (e.g., about 6100 rpm for 2 minutes) in a foaming stage 360 to yield a foam precursor 362. The foam precursor 362 can then be subjected to drying to form the foam. In some embodiments, the drying can comprise an initial drainage stage (e.g., at ambient temperature for 2-4 hours to allow free-water to naturally drain) and/or a heating stage in an oven (e.g., at a temperature in range of 50-100° C., for example, about 70° C. for about 12 hours).

In some embodiments, in addition to or in place of compromising lignin to introduce additional pores, the use of water or other solvent to form the foam and the subsequent drying can be avoided, for example, by thermal bonding of a mixture of plant material fibers with other fibers. Since the natural fibers from plant material waste (e.g., sawdust, wood chips) or pulp may be relatively short (e.g., L1≤1 cm), they cannot be twisted together to form a structural foam without another material (e.g. binder). In some embodiments, other fibers (e.g., non-plant material, such as a thermoplastic or organic fibers) that are relatively long (e.g., L2 >1 cm) can function as binder to provide structural support to the plant material fibers. By physically mixing the short natural plant material fibers with the long thermoplastic fibers, the fiber composites can be rapidly fabricated into a porous thermal insulating foam in a few minutes through an industrial-scalable thermal-bonding process that uses heat to melt the fibers and bond them together.

For example, FIG. 3C illustrates aspects of forming a foam core from a plant material using thermoplastic fibers. At mixing stage 370, plant material fibers 372 can be mixed with thermoplastic fibers 374, for example, in a blender, to form a foam precursor. At molding stage 376, the foam precursor formed by fibers 372, 374 can be disposed in a mold 378. At melting stage 380, the foam precursor within mold 378 can be subjected to an elevated temperature and/or an elevated pressure for a time (e.g., ≤10 minutes), so as to at least partially melt the thermoplastic fibers 374 and form the foam. For example, a load or compressive force 384 can be applied by a pressing plate or platen 382 to the foam precursor in mold 378 to provide the elevated pressure (e.g., ≤1 MPa, such as about 2-8 kPa). For example, the elevated temperature (e.g., ≥150° C., such as 200-250° C.) can be provided via an oven in which the mold is disposed or through the pressing platen 382 (e.g., hot press configuration).

### Fabrication Methods

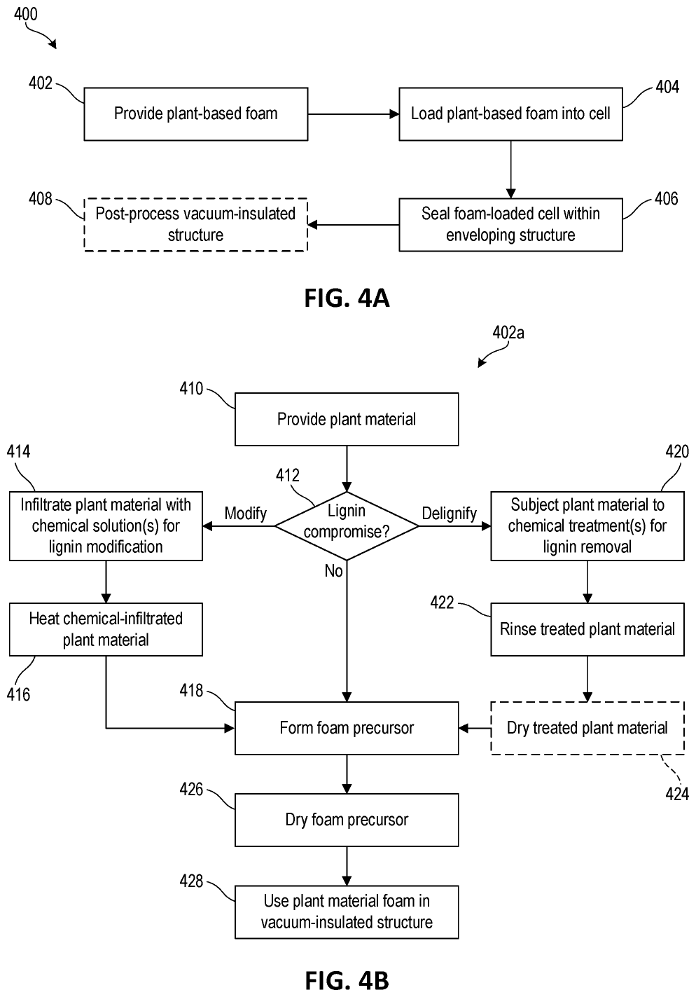

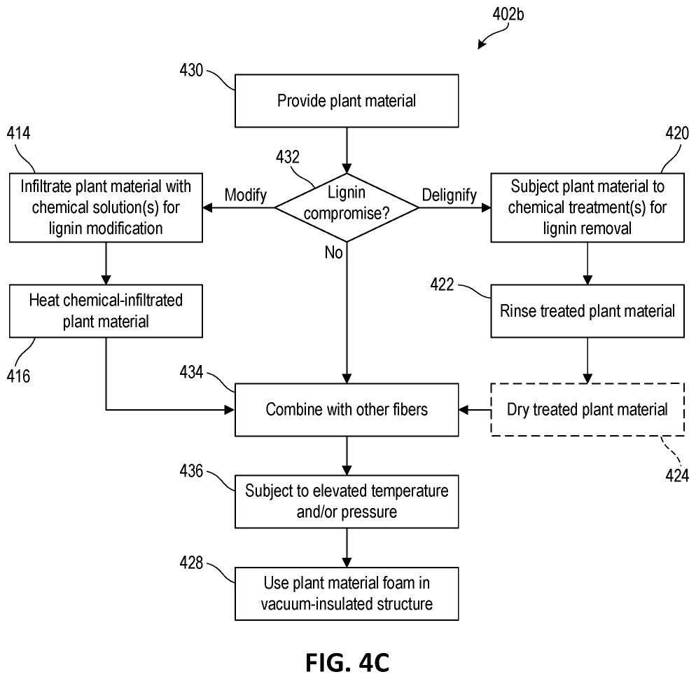

FIG. 4A illustrates aspects of a method 400 for fabricating a vacuum-insulated structure having a plant-based foam core. The method 400 can initiate at process block 402, where a plant-based foam can be provided. In some embodiments, the provision of process block 402 can include fabricating the foam, for example, via (i) drying of a foam precursor solution having the plant material and a binder or surfactant (e.g., as discussed with respect to FIG. 4B) or (ii) thermal bonding of plant material fibers with other fibers (e.g., as discussed with respect to FIG. 4C).

The method 400 can proceed to process block 404, where the foam can be loaded into a cell (or multiple cells) to form a foam core. In some embodiments, the foam can be loaded after the drying of the foam precursor. Alternatively, in some embodiments, a foam precursor can be loaded into a respective cell (or multiple cells) and then dried to form a foam core in situ.

The method 400 can proceed to process block 406, where the foam core(s) can be enclosed by an enveloping structure and vacuum sealed. For example, a cap layer of heat-reflective film can be laminated to the surface of the base layer under vacuum (e.g., vacuum level 0.1-1000 Pa) to seal the cell(s) and form the vacuum-insulated structure. The thermal conductivity of vacuum-insulated structure depends on the internal gas pressure. In some embodiments, the pressure for the core material can enable a target conductivity of 10 mW/m·K. In some embodiments, one or more support layers can be provided adjacent or at least proximal to the foam core and within the enveloping structure prior to vacuum sealing.

The method 400 can optionally proceed to process block 408, where the vacuum-insulated structure can be subject to post processing. For example, in some embodiments, additional structural and/or thermal panels can be added to the vacuum-insulated structure, such as a densified wood or bamboo panel, or a fully delignified wood or bamboo panel. Alternatively or additionally, the post processing can include cutting the vacuum-insulated structure to size, for example, by breaching at least some of the sealed cells while retaining the seal of the remaining cells. In some embodiments, the cut edges of the vacuum-insulated structure can be re-sealed and vacuumed.

Although blocks 402-408 of method 400 have been described as being performed once, in some embodiments, multiple repetitions of a particular process block may be employed before proceeding to the next decision block or process block. In addition, although blocks 402-408 of method 400 have been separately illustrated and described, in some embodiments, process blocks may be combined and performed together (simultaneously or sequentially). Moreover, although FIG. 4A illustrates a particular order for blocks 402-408, embodiments of the disclosed subject matter are not limited thereto. Indeed, in certain embodiments, the blocks may occur in a different order than illustrated or simultaneously with other blocks. In some embodiments, method 400 can include steps or other aspects not specifically illustrated in FIG. 4A. Alternatively or additionally, in some embodiments, method 400 may comprise only some of blocks 402-408 of FIG. 4A.

FIG. 4B illustrates aspects of a method 402a for fabricating a plant-based foam core by drying a foam precursor. The method 402a can initiate at process block 410, where a plant material can be provided. In some embodiments, the provision of process block 410 can include obtaining plant material chips, for example, from residues (e.g., sawdust from a wood mill), low-quality plants (e.g., small-diameter trees, forest thinnings), and/or waste plant matter (e.g., waste wood or grass from municipal solid waste). In some embodiments, the provision of process block 410 can include grinding or milling of the plant material, for example, to reduce a size of the starting material. The size of plant material chips can influence the efficiency of and protocols for the chemical treatments to compromise lignin, with smaller-sized chips usually processing faster due to shorter chemical diffusion paths.

The method 402a can proceed to decision block 412, where it is determined if the plant material should be subject to a lignin-compromising treatment. In some embodiments, lignin-compromising may not be desired, for example, where the plant material serves only as a mechanical scaffold for other porous materials. In such embodiments, the method 402a can proceed directly from decision block 412 to process block 418. Alternatively, if in situ lignin modification is desired at decision block 412, the method 402a can proceed to process block 414, wherein the plant material can be infiltrated with one or more chemical solutions to modify lignin therein. For example, in some embodiments, the infiltration can be by soaking the plant material in a solution containing the one or more chemicals under vacuum. In some embodiments, the chemical solution can contain at least one chemical component that has OH⁻ ions or is otherwise capable of producing OH⁻ ions in solution. In some embodiments, one, some, or all of the chemicals in the solution can be alkaline. In some embodiments, the chemical solution includes p-toluenesulfonic acid, NaOH, LiOH, KOH, Na₂O, or any combination thereof. Exemplary combinations of chemicals can include, but are not limited to, p-toluenesulfonic acid, NaOH, NaOH+Na₂SO₃/Na₂SO₄, NaOH+Na₂S, NaHSO₃+SO₂+H₂O, NaHSO₃+Na₂SO₃, NaOH+Na₂SO₃, NaOH/NaH₂O₃+AQ, NaOH/Na₂S+AQ, NaOH+Na₂SO₃+AQ, Na₂SO₃+NaOH+CH₃OH+AQ, NaHSO₃+SO₂+AQ, NaOH+Na₂Sx, where AQ is Anthraquinone, any of the foregoing with NaOH replaced by LiOH or KOH, or any combination of the foregoing.

For example, in some embodiments, wood can be immersed in a chemical solution (e.g., 2-5% NaOH) in a container. The container can then be placed in a vacuum box and subjected to vacuum. In this way, the air in the wood can be drawn out and form a negative pressure. When the vacuum pump is turned off, the negative pressure inside the wood can suck the solution into the wood through the natural channels therein (e.g., lumina defined by longitudinal cells). The process can be repeated more than once (e.g., 3 times), such that the channels inside the wood can be filled with the chemical solution (e.g., about 2 hours). After this process, the moisture content can increase from ˜10.2% (e.g., for natural wood) to ˜70% or greater. In some embodiments, the chemical infiltration can be performed without heating, e.g., at room temperature (20-30° C., such as ˜22-23° C.). In some embodiments, the chemical solution is not agitated in order to avoid disruption to the cellulose-based microstructure of the wood.

The method 402a can proceed to process block 416, where the modification may be activated by subjecting the infiltrated plant material to an elevated temperature, for example, greater than 80° C. (e.g., 80-180° C., such as 120-160° C.), thereby resulting in a softened plant material (e.g., softened as compared to the natural plant material). In some embodiments, the heating of process block 416 can be achieved via steam heating, for example, via steam generated in an enclosed reactor, via a steam flow in a flow-through reactor, and/or via steam from a superheated steam generator. Alternatively or additionally, in some embodiments, the heating of process block 416 can be achieved via dry heating, for example, via conduction and/or radiation of heat energy from one or more heating elements without separate use of steam. In some embodiments, during process block 416, the infiltrated plant material can be subjected to the elevated temperature for a first time period of, for example, 1-5 hours (e.g., depending on the size of the plant material, with thicker pieces requiring longer heating times). In some embodiments, after the first time period, any steam generated by heating of the infiltrated plant material can be released, for example, by opening a pressure release (e.g., relief valve) of the reactor. For example, in some embodiments, the pressure release can be effective to remove ˜50% of moisture in the modified plant material. For example, in some embodiments, the now softened plant material can have a moisture content in a range of 30-50 wt %, inclusive. In some embodiments, the plant material can be further dried to reduce the moisture content of the plant material, but without removing too much moisture that the plant material loses its softened nature (e.g., such that the moisture content is greater than or equal to ˜8-10 wt %). In some embodiments, the pre-drying may be effective to reduce a moisture content of the plant material from greater than 30 wt % (e.g., 30-50 wt %) to within a range of, for example, 10-20 wt % (e.g., ˜15 wt %). While moisture may be removed from the softened plant material via the heating and/or pre-drying (e.g., via evaporation), the removed moisture may be substantially free of residual salts and/or chemicals from the in situ lignin-modification. Rather, in some embodiments, the chemicals can be substantially consumed by the modification, and the residual salts can be retained within the microstructure of the softened plant material.

If delignification is instead desired at decision block 412, the method 402a can proceed to process block 420, where the plant material is subjected to one or more chemical treatments to remove at least some lignin therefrom, for example, by immersion of the plant material (or a portion thereof) in a chemical solution associated with the treatment. In some embodiments, each chemical treatment or only some chemical treatments can be performed under vacuum, such that the solution associated with the treatment is encouraged to fully penetrate the cell walls and lumina of the plant material. Alternatively, in some embodiments, the chemical treatment(s) can be performed under ambient pressure conditions or elevated pressure conditions (e.g., ˜6-8 bar). In some embodiments, each chemical treatment or some chemical treatments can be performed at any temperature between ambient (e.g., ˜23° C.) and an elevated temperature where the solution associated with the chemical treatment is boiling (e.g., ˜70-160° C.). In some embodiments, the solution is not agitated in order to minimize the amount of disruption to the microstructure of the plant material.

In some embodiments, the immersion time can range anywhere from 0.1 hours to 96 hours, for example, between 1 hours and 12 hours, inclusive. The amount of time of immersion within the solution may be a function of the amount of lignin to be removed, type of plant material, size of the plant material, temperature of the solution, pressure of the treatment, and/or agitation. For example, smaller amounts of lignin removal, smaller plant material size (e.g., thickness), higher solution temperature, higher treatment pressure, and agitation may be associated with shorter immersion times, while larger amounts of lignin removal, larger plant material size, lower solution temperature, lower treatment pressure, and no agitation may be associated with longer immersion times.

In some embodiments, each chemical treatment of process block 420, or at least one chemical treatment, can comprise infusing, infiltrating, or otherwise exposing the plant material to a first chemical solution at a first temperature. In some embodiments, the first chemical solution can be an alkaline solution, and the first temperature can be less than 100° C. For example, the first temperature can be in a range of 5-95° C., inclusive, such as room temperature (e.g., ˜23° C.). Alternatively or additionally, the one or more chemical treatments of process block 420 can include partially or fully immersing the plant material in a second chemical solution at a second temperature greater than the first temperature. Alternatively or additionally, at least one chemical treatment can comprise infusing, infiltrating, or otherwise exposing the plant material to the second chemical solution at the second temperature. In some embodiments, the second chemical solution can be an alkaline solution, and the second temperature can be greater than 100° C. For example, the second temperature can be in a range of 120-180° C., such as 160° C. For example, the temperature of the chemical solution can be increased to 50-180° C. for 0.1-10 h to remove 5-95% lignin and hemicellulose from the plant material. In some embodiments, the second chemical solution may be the same solution as the first chemical solution. In such cases, the first chemical solution can be heated from the first temperature to the second temperature while the plant material remains therein. Alternatively, in some embodiments, a composition of the second chemical solution can be identical to a composition of the first chemical solution, for example, by providing a fresh batch of solution for use as the second chemical solution (e.g., by removing the plant material from the first chemical solution and immersing in the second chemical solution, or by draining the first chemical solution and replacing with fresh second chemical solution). Alternatively, in some embodiments, a composition of the second chemical solution can be different from the composition of the first chemical solution.

In some embodiments, the solution of the chemical treatment(s) can include sodium hydroxide (NaOH), lithium hydroxide (LiOH), potassium hydroxide (KOH), sodium sulfite (Na₂SO₃), sodium sulfide (Na₂S), NaₙS (where n is an integer), urea (CH₄N₂O), sodium bisulfite (NaHSO₃), sulfur dioxide (SO₂), anthraquinone (AQ) (C₁₄H₈O₂), methanol (CH₃OH), ethanol (C₂H₅OH), butanol (C₄H₉OH), formic acid (CH₂O₂), hydrogen peroxide (H₂O₂), acetic acid (CH₃COOH), butyric acid (C₄H₈O₂), peroxyformic acid (CH₂O₃), peroxyacetic acid (C₂H₄O₃), ammonia (NH₃), tosylic acid (p-TsOH), sodium hypochlorite (NaClO), sodium chlorite (NaClO₂), chlorine dioxide (ClO₂), chlorine (Cl₂), or any combination of the above. Exemplary combinations of chemicals for the chemical treatment can include, but are not limited to, NaOH+Na₂SO₃, NaOH+Na₂S, NaOH+urea, NaHSO₃+SO₂+H₂O, NaHSO₃+Na₂SO₃, NaOH+Na₂SO₃, NaOH+AQ, NaOH+Na₂S+AQ, NaHSO₃+SO₂+H₂O+AQ, NaOH+Na₂SO₃+AQ, NaHSO₃+AQ, NaHSO₃+Na₂SO₃+AQ, Na₂SO₃+AQ, NaOH+Na₂S+NaₙS (where n is an integer), Na₂SO₃+NaOH+CH₃OH+AQ, C₂H₅OH+NaOH, CH₃OH+HCOOH, NH₃+H₂O, and NaClO₂+acetic acid. For example, the first and second chemical solutions can be ≤2 wt % NaOH and Na₂SO₃.

The chemical treatment can continue (or can be repeated with subsequent solutions) until a desired reduction in lignin content in the plant material is achieved. In some embodiments, the lignin content can be reduced to between 0.1% (lignin content is 0.1% of original lignin content in the natural plant material) and 99% (lignin content is 99% of original lignin content in the natural plant material). In some embodiments, the chemical treatment reduces the hemicellulose content at the same time as the lignin content, for example, to the same or lesser extent as the lignin content reduction. In some embodiments, when the plant material is hardwood, softwood, or bamboo, the lignin content after the chemical treatment(s) of process block 420 can be less than or equal to 10 wt % (e.g., less than or equal to 5 wt %, such as about 3 wt %). After the lignin chemical treatment, the plant material can have a density less than 0.10 g/cm³, for example less than 0.05 g/cm³.

The method 402a can proceed to process block 422, where rinsing can be performed. For example, the rinsing can be used to remove residual chemicals or particulate(s) resulting from the partial delignification process. For example, the delignified plant material can be partially or fully immersed in one or more rinsing solutions. The rinsing solution can be a solvent, such as but not limited to, de-ionized (DI) water, alcohol (e.g., ethanol, methanol, isopropanol, etc.), or any combination thereof. For example, the rinsing solution can be formed of equal volumes of water and ethanol. In some embodiments, the rinsing can be performed without agitation, for example, to avoid disruption of the microstructure. In some embodiments, the rinsing may be repeated multiple times (e.g., at least 3 times) using a fresh mixture rinsing solution for each iteration, or until a substantially neutral pH is measured for the chemically-treated plant material.

The method 402a can proceed to optional process block 424, where the chemically-treated plant material can be dried, for example, such that the moisture content therein is less than 15 wt % (e.g., 8-12 wt %). In some embodiments, the drying can be such that the structures of the longitudinally-extending lumina in the plant microstructure are retained (e.g., with a cross-sectional shape substantially the same as that in the native plant), for example, by avoiding surface-tension-induced collapse or crumpling from evaporation of water. For example, the drying can comprise a freeze-drying process, a critical point drying process, a solvent exchange process, or any combination of the above. For example, the freeze-drying process can include reducing a temperature of the plant material to below a freezing point of the fluid therein (e.g., less than 0° C.), then reducing a pressure to allow the frozen fluid therein to sublime (e.g., less than a few millibars). For example, the critical point drying process can include immersing the plant material in a fluid (e.g., liquid carbon dioxide), increasing a temperature and pressure of the bamboo segment past a critical point of the fluid (e.g., 7.39 MPa, 31.1° C. for carbon dioxide), and then gradually releasing the pressure to remove the now gaseous fluid. For example, the solvent exchange process can include replacing water within the plant material with an organic solvent or alcohol (e.g., acetone, ethanol, etc.), which may be more readily evaporated without collapsing the longitudinally-extending lumina. Alternatively or additionally, the drying can involve hot air drying, ambient drying, air-flow drying, moisture drying, infrared drying, vacuum drying, microwave drying, or any combination of the foregoing. For example, the chemically-treated plant material can be dried in an oven at a temperature of at least 50° C. for 1-24 hours (e.g., about 12 hours).

After process block 416 or process block 422 (or optional process block 424), or if no lignin compromising treatment is desired at decision block 412, the method 402a can proceed to process block 418, where the plant material can be used to form a foam precursor. In some embodiments, where compromising the lignin of the plant material was not desired at decision block 412, the plant material can be infused, impregnated, mixed, or otherwise combined with another porous material, such silica aerogel. Alternatively, in some embodiments, where the lignin was compromised, the lignin-compromised plant material can be combined with a binder, such as a synthetic or bio-based binder, and/or dissolved in a solvent (e.g., water) to form a foam precursor. For example, the binder can be, but is not limited to, wood glue, epoxy, agar, 2-hydroxyethyl cellulose, and carboxymethyl cellulose sodium salt. For example, dry binders can be mixed in boiling water (or other solvent) and combined with plant material chips or pulp to create a homogeneous precursor solution that can be subsequently dried (e.g., via freeze-drying, critical point drying, or solvent exchange). Alternatively or additionally, the plant material can be combined with a surfactant, for example, an anionic surfactant such as sodium dodecyl sulfate (SDS), and subsequently dried (e.g., via oven drying).

The method 402a can proceed to process block 426, where the foam precursor is dried to form a plant material foam. In some embodiments, the drying can comprise a freeze-drying process, a critical point drying process, a solvent exchange process, or any combination of the above. Alternatively or additionally, the drying can involve hot air drying, ambient drying, air-flow drying, moisture drying, infrared drying, vacuum drying, microwave drying, or any combination of the foregoing. In some embodiments, for example, where the foam precursor comprises a binder, the foam precursor can be formed by freeze-drying, which allows the water in the precursor to change directly from a solid to a vapor, thereby leaving tiny pores within the foam while avoiding structural collapse. In some embodiments, for example, where the foam precursor comprises a surfactant, the foam precursor can be oven-dried (e.g., at a temperature in a range of 50-100° C. for a time in a range of 1-24 hours). After the foam is formed at process block 426, the method 402a can proceed to process block 428, where the plant material foam is used as a core in vacuum-insulated structure, for example, as described above with respect to FIG. 4A.

Although blocks 410-428 of method 402a have been described as being performed once, in some embodiments, multiple repetitions of a particular process block may be employed before proceeding to the next decision block or process block. In addition, although blocks 410-428 of method 402a have been separately illustrated and described, in some embodiments, process blocks may be combined and performed together (simultaneously or sequentially). Moreover, although FIG. 4B illustrates a particular order for blocks 410-428, embodiments of the disclosed subject matter are not limited thereto. Indeed, in certain embodiments, the blocks may occur in a different order than illustrated or simultaneously with other blocks. In some embodiments, method 402a can include steps or other aspects not specifically illustrated in FIG. 4B. Alternatively or additionally, in some embodiments, method 402a may comprise only some of blocks 410-428 of FIG. 4B.

FIG. 4C illustrates aspects of a method 402b for fabricating a plant-based foam core by thermal bonding a foam precursor. The method 402b can initiate at process block 430, where a plant material can be provided. In some embodiments, the provision of process block 430 can include obtaining plant material pulp, dust, or fibers. In some embodiments, the provision of process block 430 can include grinding, milling, or otherwise fibrillating the plant material, for example, to release and/or extract plant material fibers.

The method 402b can proceed to decision block 432, where it is determined if the plant material fibers should be subject to a lignin-compromising treatment. In some embodiments, lignin-compromising may not be desired, and the method 402b can proceed directly from decision block 432 to process block 434. Alternatively, if in situ lignin modification is desired at decision block 432, the method 402b can proceed to process blocks 414-416 to produce a lignin-modified plant material fibers, for example, in a manner similar to that described above for method 402a of FIG. 4B. Alternatively, if lignin removal is desired at decision block 432, the method 402b can proceed to process blocks 420-424 to produce at least partially delignified plant material fibers, for example, in a manner similar to that described above for method 402a of FIG. 4B.

After process block 416 or process block 422 (or optional process block 424), or if no lignin compromising treatment is desired at decision block 432, the method 402b can proceed to process block 434, where the plant material fibers can be combined with other fibers to form a foam precursor. In some embodiments, the other fibers can have a length greater than that of the plant material fibers. For example, the other fibers can have a length greater than 1 cm, and the plant material fibers can have a length less than 1 cm. In some embodiments, the other fibers can be formed of or comprise a thermoplastic, such as polyester. Alternatively or additionally, in some embodiments, the other fibers can be formed of or comprise a non-plant or organic material.

The method 402b can proceed to process block 436, where the foam precursor can be subjected to an elevated temperature and/or elevated pressure to form the plant material foam. In some embodiments, the elevated temperature can be in a range of 150-250° C., for example, about 220° C. In some embodiments, the elevated pressure can be in a range less than 1 MPa, for example, less than or equal to 0.1 MPa (e.g., in a range of 2-8 kPa, inclusive). In some embodiments, the elevated temperature and/or elevated pressure can be applied for a time of 10 minutes or less, for example, 1 minute or less. In some embodiments, the subjecting of process block 436 can be performed using a hot press machine. After the foam is formed at process block 436, the method 402b can proceed to process block 428, where the plant material foam is used as a core in vacuum-insulated structure, for example, as described above with respect to FIG. 4B.

Although blocks 414, 416, 420-424, and 428-436 of method 402b have been described as being performed once, in some embodiments, multiple repetitions of a particular process block may be employed before proceeding to the next decision block or process block. In addition, although blocks 414, 416, 420-424, and 428-436 of method 402b have been separately illustrated and described, in some embodiments, process blocks may be combined and performed together (simultaneously or sequentially). Moreover, although FIG. 4C illustrates a particular order for blocks 414, 416, 420-424, and 428-436, embodiments of the disclosed subject matter are not limited thereto. Indeed, in certain embodiments, the blocks may occur in a different order than illustrated or simultaneously with other blocks. In some embodiments, method 402b can include steps or other aspects not specifically illustrated in FIG. 4C. Alternatively or additionally, in some embodiments, method 402b may comprise only some of blocks 414, 416, 420-424, and 428-436 of FIG. 4C.

### Fabrication Systems

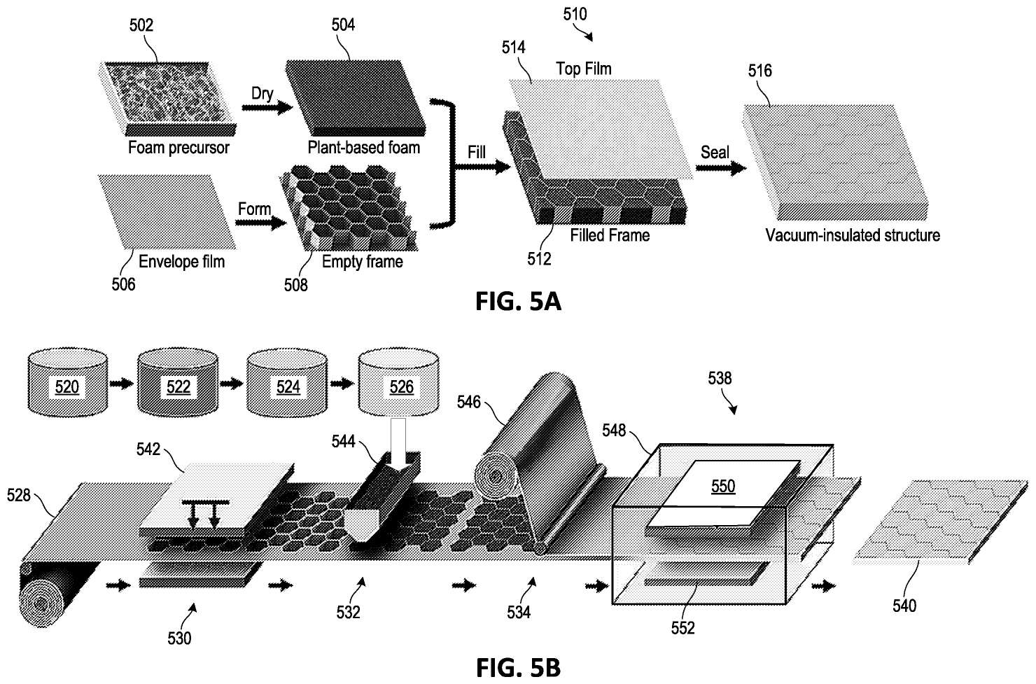

FIG. 5A illustrates an exemplary system flow for fabricating a vacuum-insulated structure 516. A foam precursor 502 can be dried to form a plant material foam 504. Alternatively or additionally, the foam 504 can be formed according to any method disclosed herein, for example, any of FIGS. 3A-3C. Before, after, or at a same time as the foam formation, a frame 508 can be formed that defines individual cells for the foam. For example, an envelope film 506 (e.g., Al-laminated film) can be vacuum formed to form the frame 508 with an array of empty cells (e.g., recesses formed by protruding portions of the envelope film). For example, a honeycomb cell array (e.g., cell size 2-10 cm) can be fabricated through, but not limited to, vacuum formation method (e.g., cold forming or thermoforming), similar to the process employed for Al-laminated films in blister packaging. Thermoforming uses a pressure bar to press directly on a heated plastic sheet to form the pockets in the blister pack, followed by rapid cooling of the plastic film to retain the blister shape. Cold forming uses stamp and mold to form the blister pockets. The foam 504 can then be loaded into the cells of the frame 508 to form a filled cell array 512 at station 510. To prevent vacuum leaks, the foam cores in the pre-formed frame 508 (e.g., honeycomb cell arrays) can be sealed by a cap layer 514 of heat-reflective film, for example, by laminating to the surface under vacuum to seal the cells and form the vacuum-insulated structure 516 (e.g., panel).

FIG. 5B illustrates an exemplary system for fabricating vacuum-insulated structures. Wood chips (e.g., or other plant material) can be subjected to a delignifying chemical treatment at station 520, for example, by immersing in one or more chemical solutions. The partially-delignified, more porous wood chips can be rinsed at station 522, and then combined with one or more binders, surfactant, and/or solvent (e.g., water) at station 524 to form a foam precursor. The foam precursor can then be dried at station 526 to form a foam. Subsequently or at a same time, an envelope film 528 can be conveyed from a supply roll to station 530, where a stamp press (or other forming method) is used to form a frame or base layer with empty cells. The foam can then be loaded into the empty cells of the base layer at station 532. The resulting foam-filled base layer can be conveyed to station 534, where a second envelope film 546 is disposed atop the base layer as a cap layer. The combination of cap layer, base layer, and foam cores can be conveyed to vacuum sealing station 538. The sealing station 538 can comprise a vacuum chamber 548 and at least one heating element, for example, top heated sealer bar/plate 550 and bottom heated sealer bar/plate 552. Within the vacuum chamber 548, the base and cap layers can be sealed together under vacuum to form the final vacuum-insulated structure 540, which may be cut from the roll (e.g., at a predetermined location with or without cells) for subsequent use.

### Additional Variations

In some embodiments, the foam precursor can be provided with stabilizers, for example, to minimize, or at least reduce, shrinking during the drying process. Alternatively or additionally, the drying process may be speed-controllable, for example, a solvent exchange process. In some embodiments, the foam precursor or the final foam can be provided with particles of non-plant material (e.g., in addition to or in place of a binder or a surfactant), for example, inorganic nanoparticles such as but not limited to silica nanoparticles.

In some embodiments, materials for the base layer, the cap layer, constituent sublayers of the base layer, constituent sublayers of the cap layer, or any combination of the foregoing can be selected to have low thermal conductivity, for example, to minimize, or at least reduce, thermal bridging.

In some embodiments, cut edges of a VIP can be re-sealed on-site after cutting and/or puncture, for example, via tape patching, thermal sealing, gluing, and/or any combination of the foregoing. In some embodiments, the on-site re-sealing can minimize, or at least reduce, edge loss after cutting.

In some embodiments, plant material chips can be chemically and/or mechanically processed to reduce a size thereof and/or produce plant material fibers or fibrils. For example, plant material can be subjected to grinding (e.g., via a disk miller or mechanical blender) prior to or after delignification. The grinding may be helpful when the plant material chips are otherwise too big to form a robust mesoporous structure through foaming.

In some embodiments, the foam can be formed without binders, which may otherwise increase material cost and/or decrease thermal insulation. For example, the foam cores can be formed by “dry-packing,” such as by using high pressure to compact small-sized plant material chips directly without adding binders. In such embodiments, the plant material particles can bind together by contact friction.

### FABRICATED EXAMPLES AND EXPERIMENTAL RESULTS

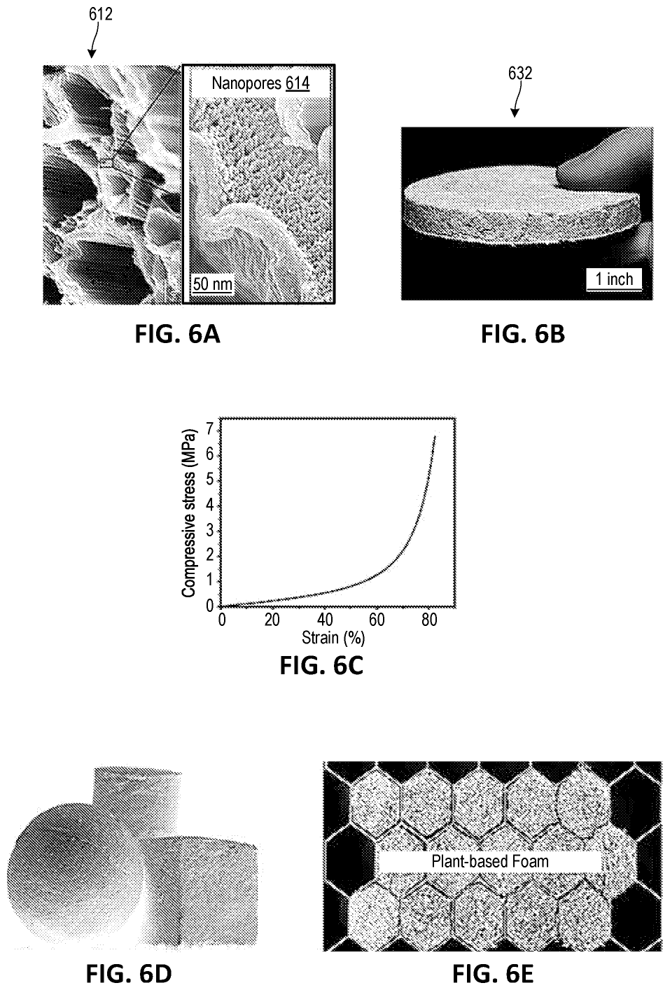

Wood chips were subjected to chemical treatment via alkaline solution to remove lignin and hemicellulose, as well as to alter the geometric structure of wood chips to increase porosity. As shown in FIG. 6A, the delignified wood chip 612 is highly porous, with pore size ranging from 100 μm to 10 nm. The nanosized pores 614 created through delignification can effectively suppress thermal transport in air by deflecting phonons, reducing the cross-sectional area of the solid, as well as increasing the tortuosity of the heat transfer pathway. In a fabricated example, vegetable gelatin agar was used as the binder to glue delignified nanoporous wood chips together, as shown in FIG. 6B. The resulting wood foam contained 5 wt % agar binder and exhibited a low density of ˜0.1 g/cm³. The wood chip foam also exhibits high mechanical performance, with stress of 2 MPa as the strain increases to 70%, as shown in FIG. 6C. In some embodiments, the foam core and/or the panel structure can be constructed to withstand 0.1 MPa (e.g., a compressive strength of at least 5 MPa). Note that both the thermal conductivity and mechanical strength of the wood chip foam can be tuned by the delignification level of the wood chips and the content of binder. Although FIG. 6B illustrates a substantially planar configuration for the foam 632, embodiments of the disclosed subject matter are not limited thereto. Rather, the foam can be formed into any of various shapes and sizes depending on the application, for example, as shown in FIG. 6D.

In some embodiments, the delignification process can remove only a small amount of lignin in wood chips (˜5-10%), for example, to generate sufficient nanopores to reduce the thermal conductivity. As compared to conventional delignification processes, the energy efficiency and processing speed can be greatly improved. In some embodiments, a rapid delignification process can be employed, for example, by using a pressurized hydrothermal vessel (e.g., a hydrothermal digester) to reach a reaction temperature of 160° C. (e.g., using alkaline liquors, such as NaOH and Na₂SO₃). After delignification, the wood chips can be rinsed with hot water (e.g., 30-100° C.) to remove remaining chemicals. For example, at 160° C., the lignin and hemicellulose in the wood chips can be effectively removed in a few minutes with a very low alkaline concentration (e.g., ˜2 wt. %). In some embodiments, the processing liquids and chemical waste can be reused and recycled, for example, using the chemical recovery method typically employed in the paper pulp industry, which can further reduce material and processing costs and minimize environmental impact.

In some embodiments, lignin can be measured based on the Technical Association of Pulp and Paper Industry (TAPPI), Standard T 222-om-83, “Standard Test Method for Acid-Insoluble Lignin in Wood,” which is incorporated by reference herein. For example, 1 g of dry wood powder (m0) can be extracted with ethanol alcohol for 4 h to remove extracts such as resin, fat, and wax. Then, the wood powder after extraction can be treated with cold H₂SO₄ (72%, 15 mL) for 2 h with vigorous stirring at 20° C. The mixture can then be transferred to a beaker and diluted to 3 wt. % H₂SO₄ by adding 560 mL of DI water and boiled for 4 h. Finally, the solution can be filtered and washed with DI water. The insoluble part can then be dried and weighed (m1). The lignin content can be calculated as: [m1/m0]×100%. Lignin content can be used as an indicator to optimize delignification parameters, including reaction time, temperature, and chemical dosage. Representative preliminary results show a 50% lignin removal for wood chips with a short reaction time of 10 min and low chemical concentration of 1.6 wt. %.

In some embodiments, industrial kraft pulping processes can be adapted for wood chips with dimensions of approximately 5 cm×5 cm×5 mm (W×L×T) to achieve controllable lignin levels. For example, the reaction temperature was 160° C. for hardwood species and 170° C. for softwood species. Chemical loadings for kraft pulping were approximately 4-5 wt % NaOH and 1.5 wt % Na₂S, with a liquor-to-wood chips ratio of 4:1 (L/W). A wide range of removed lignin can be achieved by controlling reaction times and chemical concentrations. Rapid removal of 5-10% lignin can be achieved in 20 mins. Compared to delignifying paper and pulp, producing delignified wood chips is much faster because of the small amount of lignin that is removed.

In a fabricated example, a partially-delignified wood-chip foam was encased in a thin, gas-tight outer envelope. The envelope was constructed with an outer heat-reflective layer (aluminum) and an inner sealing layer (polyester), whose air permeability is as low as 0.001 cm²/(m²·day). Benefitting from the high compressive strength, the wood chip foam has only minor shape deformation caused by the pressure difference between inner and outer layers of the vacuum-insulated panel (VIP). To fabricate the VIP, the prepared wood foam was first filled into the empty pre-formed cell-arrays (e.g., metal-polymer base layer), as shown in FIG. 6E. Then the envelope was laminated with a cap layer of metal-polymer film (which may be the same or different composition as the base layer) on the top surface under vacuum to seal the cells and form the panel. These isolated vacuum cells enable the VIP to be cut to size onsite without air leaking through the entire panel pouch. Instead, the vacuum loss will be constrained to only a few cells that are adjacent to the cut. Evaluation of thermal conductivity as a function of service time with a consideration of air diffusion on heat conduction indicates that gas barrier layers can effectively minimize the air diffusion rate, enabling the VIP to retain a thermal conductivity of R13.5 after 50 years.

To ensure that the final foam was 100% sustainable and biodegradable, binders derived from natural plants were considered, in particular, aga, 2-hydroxethyl cellulose (2-HEC) sodium salt, and carboxymethyl cellulose (CMC) sodium salt. Agar is a mixture of the linear polysaccharides agarose and a heterogeneous mixture of agaropectin. To prepare and activate the agar binder, a beaker with de-ionized (DI) water was boiled. After the water was boiling, dry agar powder was slowly added to the beaker and mixed until fully dissolved. 2-HEC is a polymer obtained by treating cellulose with sodium hydroxide and reacting with ethylene oxide. To prepare and activate the 2-HEC binder, the process described above for the agar preparation was followed. CMC has a very high viscosity (1500-3000 centipoise for a 1% solution) and is a common form of cellulose gum. To prepare and activate the CMC binder, dry CMC powder was slowly added to a beaker of DI water with a stir bar. The beaker was covered with plastic wrap and left to stir overnight until evenly dispersed throughout the DI water, resulting in a gel-like solution.

Table 1 below reflects the influence of binder types and binder concentrations on the density and thermal conductivity of the foams made by freeze drying. As reflected in the data, the density versus binder type varies according to the starter material (e.g., pine pulp, poplar, paulownia). As the mixed 2-HEC/agar binder content increases for poplar samples, the density of the nanochip foam also increases. For example, with the poplar samples, when the mixed 2-HEC/agar binder content increases from 6% to 12%, the density of the nanochip foam increases from ˜0.05 g/cm³ (Sample No. 4) to ˜0.11 g/cm³ (Sample No. 5). For the paulownia samples, when the binder content increases from 4% to 7%, the density of the nanochip foam increases from ˜0.05 g/cm³ (Sample No. 13) to ˜0.06 g/cm³ (Sample No. 17). For the pine pulp samples, when the mixed 2-HEC/Agar binder content increases from 1% to ˜2.5%, the density of the nanochip foam increases from ˜0.06 g/cm³ (Sample No. 25) to ˜0.11 g/cm³ (Sample No. 31). The influence of binder types on the density of the nanochip foams is minor. As the density increases from ˜0.05 g/cm³ to ˜0.11 g/cm³, the thermal conductivity of the foam first decreases then increases. The lowest measured thermal conductivity value of foam was 0.0395 W/(m·K) for the 2.4% Mixed 2-HEC/Agar Southern Yellow Pine Pulp Foam, which had a density of 0.0831 g/cm³.

TABLE 1
Influence of Binder Type and Concentration on Foam Properties

| | | | | | Thermal |
|---|---|---|---|---|---|
| Sample | Plant | Binder | Binder | Density | Conductivity |
| No. | Material | (wt %) | Type | (g/cm³) | [W/(m · K)] |
| 2 | Poplar chips | 2.58 | 2-HEC/Agar | 0.1073 | 0.04742 |
| 4 | Poplar chips | 6.29 | 2-HEC/Agar | 0.0531 | 0.04469 |
| 5 | Poplar chips | 12.25 | 2-HEC/Agar | 0.1065 | 0.04216 |
| 8 | Poplar chips | 12.25 | 2-HEC/Agar | 0.0787 | 0.04127 |
| 10 | Poplar chips | 9.19 | 2-HEC/Agar | 0.0782 | 0.04108 |
| 12 | Hardwood pulp | 0.04 | CMC | 0.0635 | 0.04202 |
| 13 | Paulownia | 4.14 | 2-HEC/Agar | 0.0545 | 0.04296 |
| | chips | | | | |
| 14 | Poplar chips | 1.99 | CMC | 0.070 | 0.04262 |
| 15 | Paulownia | 2.91 | 2-HEC/Agar | 0.1067 | 0.03910 |
| | chips | | | | |
| 17 | Paulownia | 6.57 | 2-HEC/Agar | 0.0619 | 0.04955 |
| | chips | | | | |
| 19 | Paulownia | 0.07 | CMC | 0.0590 | 0.03979 |
| | chips | | | | |
| 21 | Pine pulp | 2.41 | 2-HEC/Agar | 0.0831 | 0.03949 |

Pulp produced by industrial processes has a lower lignin content, as the industrial pulping conditions hydrolyze hemicellulose and lignin from the fibers. As a result, commercially produced pulp can be used in lieu of separate delignification, thus saving time, energy, chemicals, and reducing manufacturing cost. Two different types of commercial pulp, including southern yellow pine pulp (lignin content ˜15%) and hardwood pulp (lignin content ˜6%), were selected. Based on the thermal conductivity measurements, the pulp is closely comparable to the delignified wood chips.

TABLE 2
Properties of Foam formed from Wood Pulp

| | | | | | Thermal |
|---|---|---|---|---|---|
| Sample | Plant | Binder | Binder | Density | Conductivity |
| No. | Material | (wt %) | Type | (g/cm³) | [W/(m · K)] |
| 25 | Pine pulp | 1.21 | 2-HEC/Agar | 0.0595 | 0.04758 |
| 26 | Hardwood pulp | 5.06 | CMC | 0.0398 | 0.04212 |
| 27 | Hardwood pulp | 5.06 | 2-HEC/Agar | 0.0523 | 0.04518 |
| 29 | Pine pulp | 2.41 | 2-HEC/Agar | 0.1229 | 0.04139 |
| 30 | Pine pulp | 2.41 | 2-HEC/Agar | 0.1103 | 0.04197 |
| 31 | Pine pulp | 2.41 | 2-HEC/Agar | 0.1131 | 0.04143 |

Due to the trade-off relationship between solid conduction and gaseous conduction, the thermal conductivity of foams with a density of ˜0.04 g/cm³ show a minimized thermal conductivity in air. However, the gaseous thermal conductivity was completely suppressed under vacuum, and the lower density indicates a reduced solid conduction. Therefore, the foam with a density of 0.0386 g/cm³ (hardwood pulp and 5% CMC binder by dry wt wood) was selected for thermal conductivity measurements. The measured thermal conductivity was 0.0406 W/(m·K) in air. The thermal conductivity of the foam decreases as pressure decreases, for example, to 8.1 mW/(m·K) as the pressure decreases to 6.9×10⁻⁴ mBar (0.069 Pa).

To avoid the energy-intensive and high-cost freeze drying process, oven-drying was explored. Surfactant was used to introduce a large amount of air bubbles throughout the sample, which resists the structural collapse during oven-drying. White pulp board was ground in a grinder for 2 minutes and added to a beaker full of water and microfibrillated cellulose slurry. The mixture was then blended for 3 minutes at about 17,900 rpm to yield a uniform dispersion. The mixture was then left to soak overnight (e.g., ˜12 hours). To make the foam, surfactant was added to a blender with the pulp/water/slurry mixture and blended for 2 minutes at about 6,100 rpm. The homogeneous mixture was poured into a mold and allowed to drain free-water at ambient conditions for 2-4 hours. The molds were then transferred into an oven at 70° C. for overnight drying (e.g., ˜12 hours).

The effect of SDS and pulp contents on the thermal conductivity and density was measured, and the results are reflected in Table 3 below. A lower concentration of SDS can lead to a foam with a lower density. Due to the increased gaseous heat transfer contributed by convention inside pores and radiative heat transfer, the thermal conductivity of the foam can reach as high as 0.065 W/(m·K) when its density is around 0.015 g/cm³. As the density increases (porosity decreases) to 0.011 g/cm³, the convective and radiative heat transfer were suppressed, and the thermal conductivity of the foam decreases to 0.03579 W/(m·K).

TABLE 3
Properties of Foam formed using Surfactant.

| | | | | Thermal |
|---|---|---|---|---|
| Fiber | Surfactant | Surfactant | Density | Conductivity |
| (wt %) | (wt %) | Type | (g/cm³) | [W/(m · K)] |
| 1.76 | 1.2 | SDS | 0.0110 | 0.03579 |
| 1.76 | 1.2 | SDS | 0.0110 | 0.03693 |
| 1.76 | 1.2 | SDS | 0.0032 | 0.05438 |
| 3 | 1.7 | SDS | 0.0012 | 0.03729 |
| 4.5 | 0.8 | SDS | 0.0012 | 0.05390 |
| 4.5 | 1.2 | SDS | 0.0015 | 0.06548 |

The freeze-dried and oven-dried foam forming processes both involve water and take significant amounts of time to produce (e.g., >10 hours). Moreover, since the natural fibers from wood waste (i.e., sawdust, wood chips) or pulp are short (<1 cm), they cannot be twisted together to form a structural foam. As a result, another material (i.e., long fibers) that functions as binder can be used to provide structural support. Recycled polyester fibers that are derived from the postconsumer waste of plastic bottles can be used as thermal binders. They use less energy in fiber manufacturing than the conventional virgin polyester fibers and can reduce carbon footprint by recycling the plastic bottles that would otherwise go into the landfills. By physically mixing the short natural fibers with the long recycled polyester fibers, the fiber composites can be rapidly fabricated into a porous thermal insulating foam in a few minutes through an industrial scalable thermal-bonding process that uses heat to melt the fibers and bond them together.

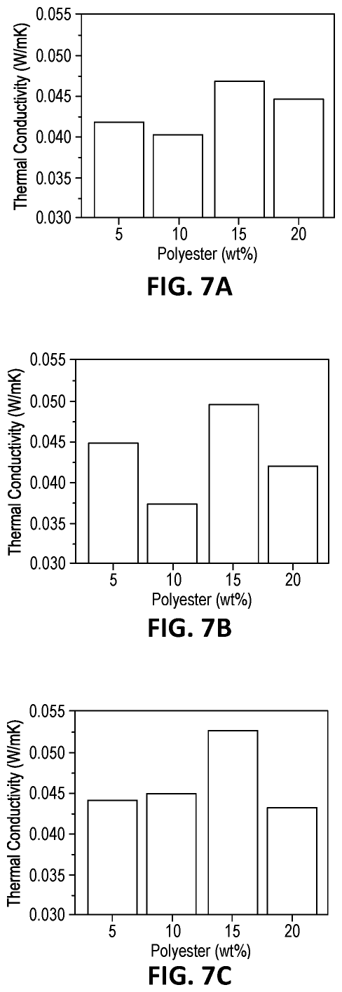

Polyester fibers (e.g., weight ratio ranges from 5% to 15%) were mixed with the pulp fibers using a blender with a speed of 15000 rpm for a time in a range of 15 seconds to 2 minutes. The uniformly mixed fibers were transferred into a metal mold with a size of 6 inch×6 inch. The mold was then placed into an oven chamber at a temperature of at least 150° C. (e.g., in a range of 220-240° C.) for a time of 10 minutes or less (e.g., less than 1 minute). At a same time, a pressure of 0.1 MPa or less (e.g., 2-8 kPa) was applied to the mold to ensure that the polyester fibers were melted and bonded together with the wood fibers. The formed thermally-bonded wood-polyester foams had a density in a range of 0.08 g/cm³ to 0.214 g/cm³, inclusive. The effect of varying polyester content and pressure applied during the fabrication process on thermal conductivity was measured, and the results are shown in FIGS. 7A-7C. As suggested by the data, using 10 wt % polyester can minimize the thermal conductivity of the thermally-bonded foams.

### ADDITIONAL EXAMPLES OF THE DISCLOSED TECHNOLOGY

In view of the above-described implementations of the disclosed subject matter, this application discloses the additional examples in the clauses enumerated below. It should be noted that one feature of a clause in isolation, or more than one feature of the clause taken in combination, and, optionally, in combination with one or more features of one or more further clauses are further examples also falling within the disclosure of this application.

Clause 1. A vacuum-insulated structure comprising:
one or more internal cells;
one or more foam cores, each foam core comprising a plant material and being disposed within a respective one of the one or more cells; and
an enveloping structure sealing each foam core within the respective cell at a pressure less than atmospheric pressure.

Clause 2. The vacuum-insulated structure of any clause or example herein, in particular, Clause 1, wherein each foam core comprises and/or is formed from a non-plant material.

Clause 3. The vacuum-insulated structure of any clause or example herein, in particular, Clause 2, wherein the non-plant material comprises glass fiber, fumed silica, open-cell polymer foam, glass foam, or any combination of the foregoing.

Clause 4. The vacuum-insulated structure of any clause or example herein, in particular, any one of Clauses 1-3, wherein each foam core comprises or is formed from a plant material.

Clause 5. The vacuum-insulated structure of any clause or example herein, in particular, Clause 4, wherein the plant material comprises wood, bamboo, reed, grass, bagasse, or straw.

Clause 6. The vacuum-insulated structure of any clause or example herein, in particular, any one of Clauses 1-5, wherein the enveloping structure comprises a base layer and a cap layer disposed over the base layer.

Clause 7. The vacuum-insulated structure of any clause or example herein, in particular, Clause 6, wherein the base layer at least partly defines and/or bounds the one or more internal cells.

Clause 8. The vacuum-insulated structure of any clause or example herein, in particular, any one of Clauses 6-7, wherein each cell comprises a recess formed by respective protruding portions of the base layer.

Clause 9. The vacuum-insulated structure of any clause or example herein, in particular, any one of Clauses 6-8, wherein the base layer comprises a densified, lignin-compromised piece of wood or bamboo, and/or the cap layer comprises a densified, lignin-compromised piece of wood or bamboo.

Clause 10. The vacuum-insulated structure of any clause or example herein, in particular, any one of Clauses 6-9, wherein the enveloping structure further comprises a gas-barrier film enclosing the base layer, the cap layer, the one or more internal cells, and the one or more foam cores.

Clause 11. The vacuum-insulated structure of any clause or example herein, in particular, any one of Clauses 1-10, further comprising a frame disposed within the enveloping structure and at least partly defining and/or bounding the one or more internal cells.

Clause 12. The vacuum-insulated structure of any clause or example herein, in particular, Clause 11, wherein the frame comprises a polymer.

Clause 13. The vacuum-insulated structure of any clause or example herein, in particular, any one of Clauses 11-12, wherein the frame comprises a closed-cell foam.

Clause 14. The vacuum-insulated structure of any clause or example herein, in particular, any one of Clauses 11-13, wherein the frame is composed of polyurethane or polyethylene.

Clause 15. The vacuum-insulated structure of any clause or example herein, in particular, any one of Clauses 11-14, wherein the frame comprises a densified, lignin-compromised piece of wood or bamboo.

Clause 16. The vacuum-insulated structure of any clause or example herein, in particular, any one of Clauses 4-15, wherein the plant material in one, some, or all of the one or more foam core comprises lignin-compromised plant material.

Clause 17. The vacuum-insulated structure of any clause or example herein, in particular, Clause 16, wherein the lignin-compromised plant material comprises modified lignin therein, and the modified lignin has shorter macromolecular chains than that of native lignin in the natural plant material.

Clause 18. The vacuum-insulated structure of any clause or example herein, in particular, Clause 17, wherein a content of the modified lignin in the one, some, or all of the one or more foam cores is at least 90%, on a weight percentage basis, of a content of the native lignin in the natural plant material.

Clause 19. The vacuum-insulated structure of any clause or example herein, in particular, any one of Clauses 17-18, wherein a content of the modified lignin in the one, some, or all of the one or more foam cores is at least 20 wt %.

Clause 20. The vacuum-insulated structure of any clause or example herein, in particular, any one of Clauses 17-19, wherein the one, some, or all of the one or more foam cores comprises a salt of an alkaline chemical immobilized within a cellulose-based microstructure of the lignin-compromised plant material.

Clause 21. The vacuum-insulated structure of any clause or example herein, in particular, Clause 20, wherein the salt is substantially pH-neutral.

Clause 22. The vacuum-insulated structure of any clause or example herein, in particular, Clause 16, wherein the lignin-compromised plant material is at least partially delignified plant material.

Clause 23. The vacuum-insulated structure of any clause or example herein, in particular, Clause 22, wherein a lignin content of the at least partially delignified plant material is between 10% and 99%, inclusive, of a lignin content of the natural plant material.

Clause 24. The vacuum-insulated structure of any clause or example herein, in particular, any one of Clauses 22-23, wherein:
the plant material is a hardwood, and a lignin content of the at least partially delignified plant material is between 1.8 wt % and 24.8 wt %, inclusive; or
the plant material is a softwood, and a lignin content of the at least partially delignified plant material is between 2.5 wt % and 34.7 wt %, inclusive.

Clause 25. The vacuum-insulated structure of any clause or example herein, in particular, any one of Clauses 22-24, wherein a lignin content of the at least partially delignified plant material is less than or equal to 10 wt %.

Clause 26. The vacuum-insulated structure of any clause or example herein, in particular, any one of Clauses 22-25, wherein a lignin content of the at least partially delignified plant material is less than 10%, on a weight percentage basis, of a lignin content of natural plant material.

Clause 27. The vacuum-insulated structure of any clause or example herein, in particular, any one of Clauses 22-26, wherein:
the plant material is a hardwood, and a lignin content of the at least partially delignified plant material is less than 2.5 wt %; or
the plant material is a softwood, and a lignin content of the at least partially delignified plant material is less than 3.5 wt %.

Clause 28. The vacuum-insulated structure of any clause or example herein, in particular, any one of Clauses 1-27, wherein one, some, or all of the one or more foam cores has a density less than or equal to 0.1 g/cm³.

Clause 29. The vacuum-insulated structure of any clause or example herein, in particular, any one of Clauses 1-28, wherein one, some, or all of the one or more foam cores further comprises a binder.

Clause 30. The vacuum-insulated structure of any clause or example herein, in particular, Clause 29, wherein a content of the binder in one, some, or all of the one or more foam cores is less than or equal to 10 wt %.

Clause 31. The vacuum-insulated structure of any clause or example herein, in particular, any one of Clauses 29-30, wherein the binder comprises a biopolymer (e.g., a natural polymer produced by cells of a living organism).

Clause 32. The vacuum-insulated structure of any clause or example herein, in particular, any one of Clauses 29-31, wherein the binder comprises wood glue, epoxy, agar, 2-hydroxyethyl cellulose, carboxymethyl cellulose sodium salt, or any combination of the foregoing.

Clause 33. The vacuum-insulated structure of any clause or example herein, in particular, any one of Clauses 29-32, wherein the binder comprises melted thermoplastic or organic fibers.

Clause 34. The vacuum-insulated structure of any clause or example herein, in particular, Clause 33, wherein the thermoplastic fibers comprise polyester.

Clause 35. The vacuum-insulated structure of any clause or example herein, in particular, any one of Clauses 1-34, wherein:
the plant material in one, some, or all of the foam cores comprises plant material fibers having a first length;
the one, some, or all of the one or more foam cores further comprise other fibers having a second length; and
the second length is greater than the first length.

Clause 36. The vacuum-insulated structure of any clause or example herein, in particular, Clause 35, wherein the other fibers comprise thermoplastic or organic fibers.

Clause 37. The vacuum-insulated structure of any clause or example herein, in particular, any one of Clauses 35-36, wherein the first length is less than or equal to 1 μm and the second length is less than or equal to 100 μm, or the first length is less than 1 mm and the 15 second length is greater than or equal to 1 mm, or the first length is less than 1 cm and the second length is greater than or equal to 1 cm.

Clause 38. The vacuum-insulated structure of any clause or example herein, in particular, any one of Clauses 1-37, wherein one, some, or all of the one or more foam cores further comprise microfibrillated cellulose.

Clause 39. The vacuum-insulated structure of any clause or example herein, in particular, any one of Clauses 1-38, wherein one, some, or all of the one or more foam cores further comprise inorganic nanoparticles.

Clause 40. The vacuum-insulated structure of any clause or example herein, in particular, Clause 39, wherein the inorganic nanoparticles comprise silica.

Clause 41. The vacuum-insulated structure of any clause or example herein, in particular, any one of Clauses 1-40, wherein one, some, or all of the one or more foam cores further comprise a surfactant or residue of the surfactant.

Clause 42. The vacuum-insulated structure of any clause or example herein, in particular, Clause 41, wherein the surfactant comprises sodium dodecyl sulfate.

Clause 43. The vacuum-insulated structure of any clause or example herein, in particular, any one of Clauses 1-42, wherein the plant material in one, some, or all of the one or more foam cores is in a form of chips, pulp, and/or fibers.

Clause 44. The vacuum-insulated structure of any clause or example herein, in particular, any one of Clauses 1-43, wherein the vacuum-insulated structure is an insulating panel, and/or the vacuum-insulated structure has a thermal conductivity less than or equal to 45 mW/(m·K).

Clause 45. The vacuum-insulated structure of any clause or example herein, in particular, any one of Clauses 1-44, wherein a pressure within one, some, or all of the one or more internal cells is less than or equal to 100 Pa.

Clause 46. The vacuum-insulated structure of any clause or example herein, in particular, any one of Clauses 1-45, wherein a pressure within one, some, or all of the one or more internal cells is about 10 Pa.

Clause 47. The vacuum-insulated structure of any clause or example herein, in particular, any one of Clauses 1-46, wherein the one or more internal cells is a plurality of internal cells arranged in a hexagonal or rectangular array.

Clause 48. The vacuum-insulated structure of any clause or example herein, in particular, any one of Clauses 4-47, wherein the plant material is wood or bamboo.

Clause 49. A method comprising:
(a) providing one or more foam cores in one or more cells, each foam core comprising a plant material and being disposed within a respective one of the one or more cells; and
(b) sealing an enveloping structure under vacuum to form a vacuum-insulated structure and such that each foam core within the respective cell is sealed at a pressure less than atmospheric pressure.

Clause 50. The method of any clause or example herein, in particular, Clause 49, wherein each foam core comprises and/or is formed from a non-plant material.

Clause 51. The method of any clause or example herein, in particular, Clause 50, wherein the non-plant material comprises glass fiber, fumed silica, open-cell polymer foam, glass foam, or any combination of the foregoing.

Clause 52. The method of any clause or example herein, in particular, any one of Clause 49-51, wherein each foam core comprises or is formed from a plant material.

Clause 53. The method of any clause or example herein, in particular, Clause 52, wherein the plant material comprises wood, bamboo, reed, grass, bagasse, or straw.

Clause 54. The method of any clause or example herein, in particular, any one of Clauses 49-53, wherein the providing of (a) comprises subjecting a piece of natural plant material having native lignin therein to a chemical treatment so as to compromise the native lignin, thereby forming a piece of lignin-compromised plant material.

Clause 55. The method of any clause or example herein, in particular, Clause 54, wherein, after the subjecting, the piece of lignin-compromised plant material has modified lignin therein, and the modified lignin has shorter macromolecular chains than that of native lignin in the piece of natural plant material.

Clause 56. The method of any clause or example herein, in particular, any one of Clauses 54-55, wherein the subjecting to the chemical treatment comprises:
(a1) infiltrating the piece of natural plant material with one or more chemical solutions; and
(a2) after (a1), subjecting the piece of natural plant material with one or more chemical solutions therein to a first temperature of at least 80° C. for a first time, so as to form the piece of lignin-compromised plant material.

Clause 57. The method of any clause or example herein, in particular, Clause 56, wherein the one or more chemical solutions comprise p-toluenesulfonic acid, NaOH, NaOH+Na₂SO₃/Na₂SO₄, NaOH+Na₂S, NaHSO₃+SO₂+H₂O, NaHSO₃+Na₂SO₃, NaOH+Na₂SO₃, NaOH/NaH₂O₃+AQ, NaOH/Na₂S+AQ, NaOH+Na₂SO₃+AQ, Na₂SO₃+NaOH+CH₃OH+AQ, NaHSO₃+SO₂+AQ, NaOH+Na₂Sx, where AQ is Anthraquinone, any of the foregoing with NaOH replaced by LiOH or KOH, or any combination of the foregoing.

Clause 58. The method of any clause or example herein, in particular, any one of Clauses 56-57, wherein the first temperature is in a range of 120-160° C., inclusive, and/or the first time is in a range of 1-5 hours, inclusive.

Clause 59. The method of any clause or example herein, in particular, any one of Clauses 56-58, wherein at least 90% of the one or more chemical solutions infiltrated into the piece of natural plant material is consumed during (a2).

Clause 60. The method of any clause or example herein, in particular, any one of Clauses 56-59, wherein the subjecting to the first temperature of (a2) comprises using steam to heat the piece of natural plant material with the one or more chemical solutions therein.

Clause 61. The method of any clause or example herein, in particular, any one of Clauses 56-60, wherein, after (a2), a content of the modified lignin in the piece of lignin-compromised plant material is at least 90%, on a weight percentage basis, of a content of the native lignin in the piece of natural plant material, and/or a content of the modified lignin in the piece of lignin-compromised plant material is at least 20 wt %.

Clause 62. The method of any clause or example herein, in particular, any one of Clauses 56-61, wherein, after (a2), a salt of an alkaline chemical is immobilized within a cellulose-based microstructure of the piece of lignin-compromised plant material.

Clause 63. The method of any clause or example herein, in particular, Clause 62, wherein the salt is substantially pH-neutral.

Clause 64. The method of any clause or example herein, in particular, any one of Clauses 62-63, wherein the salt is formed by reaction of the one or more chemical solutions with an acidic degradation product of native hemicellulose in the piece of natural plant material produced by the one or more chemical solutions during (a2).

Clause 65. The method of any clause or example herein, in particular, Clause 54, wherein, after the subjecting, the piece of lignin-compromised plant material is at least partially delignified plant material.

Clause 66. The method of any clause or example herein, in particular, Clause 65, wherein the subjecting to the chemical treatment comprises partial or full immersion in one or more chemical solutions at a second temperature for a second time, so as to remove at least some lignin from the piece of natural plant material.

Clause 67. The method of any clause or example herein, in particular, Clause 66, wherein the one or more chemical solutions comprise an alkaline solution.

Clause 68. The method of any clause or example herein, in particular, any one of Clauses 66-67, wherein the one or more chemical solutions comprise sodium hydroxide (NaOH), lithium hydroxide (LiOH), potassium hydroxide (KOH), sodium sulfite (Na₂SO₃), sodium sulfate (Na₂SO₄), sodium sulfide (Na₂S), NaₙS wherein n is an integer, urea (CH₄N₂O), sodium bisulfite (NaHSO₃), NaH₂O₃, sulfur dioxide (SO₂), anthraquinone (C₁₄H₈O₂), methanol (CH₃OH), ethanol (C₂H₅OH), butanol (C₄H₉OH), formic acid (CH₂O₂), hydrogen peroxide (H₂O₂), acetic acid (CH₃COOH), butyric acid (C₄H₈O₂), peroxyformic acid (CH₂O₃), peroxyacetic acid (C₂H₄O₃), ammonia (NH₃), tosylic acid (p-TsOH), sodium hypochlorite (NaClO), sodium chlorite (NaClO₂), chlorine dioxide (ClO₂), chorine (Cl₂), water (H₂O) or any combination of the above.

Clause 69. The method of any clause or example herein, in particular, any one of Clauses 66-68, wherein the one or more chemical solutions comprise a boiling mixture of NaOH and Na₂SO₃.

Clause 70. The method of any clause or example herein, in particular, any one of Clauses 66-69, wherein the second temperature is in a range of 100-160° C., inclusive, and/or the second time is in a range of 0.1-96 hours, inclusive.

Clause 71. The method of any clause or example herein, in particular, any one of Clauses 65-70, wherein a lignin content of the at least partially delignified plant material is between 10% and 99%, inclusive, of a lignin content of the natural plant material.

Clause 72. The method of any clause or example herein, in particular, any one of Clauses 65-71, wherein:
the plant material is a hardwood, and a lignin content of the at least partially delignified plant material is between 1.8 wt % and 24.8 wt %, inclusive; or
the plant material is a softwood, and a lignin content of the at least partially delignified plant material is between 2.5 wt % and 34.7 wt %, inclusive.

Clause 73. The method of any clause or example herein, in particular, any one of Clauses 65-72, wherein a lignin content of the at least partially delignified plant material is less than or equal to 10 wt %.

Clause 74. The method of any clause or example herein, in particular, any one of Clauses 65-73, wherein a lignin content of the at least partially delignified plant material is less than 10% of a lignin content of the natural plant material.

Clause 75. The method of any clause or example herein, in particular, any one of Clauses 65-74, wherein:
the plant material is a hardwood, and a lignin content of the at least partially delignified plant material is less than 2.5 wt %; or
the plant material is a softwood, and a lignin content of the at least partially delignified plant material is less than 3.5 wt %.

Clause 76. The method of any clause or example herein, in particular, any one of Clauses 54-75, wherein the providing of (a) further comprises:
mixing the piece of lignin-compromised plant material with a binder to form a foam precursor;
drying the foam precursor to form one of the one or more foam cores; and
disposing the formed foam core into a respective one of the one or more cells.

Clause 77. The method of any clause or example herein, in particular, Clause 76, wherein the drying comprises freeze-drying or critical point drying.

Clause 78. The method of any clause or example herein, in particular, any one of Clauses 76-77, wherein a content of the binder in the formed foam core is less than or equal to 10 wt %.

Clause 79. The method of any clause or example herein, in particular, any one of Clauses 76-78, wherein the binder comprises a biopolymer.

Clause 80. The method of any clause or example herein, in particular, any one of Clauses 76-79, wherein the binder comprises wood glue, epoxy, agar, 2-hydroxyethyl cellulose, carboxymethyl cellulose sodium salt, or any combination of the foregoing.

Clause 81. The method of any clause or example herein, in particular, any one of Clauses 54-80, wherein the providing of (a) further comprises:
mixing the piece of lignin-compromised plant material with a binder to form a foam precursor;
subjecting the foam precursor to an elevated temperature, an elevated pressure, or both an elevated temperature and pressure so as to at least partially melt the binder, thereby forming one of the one or more foam cores; and
disposing the formed foam core into a respective one of the one or more cells.

Clause 82. The method of any clause or example herein, in particular, any one of Clauses 49-53, wherein the providing of (a) comprises:
mixing the plant material with a binder to form a foam precursor;
subjecting the foam precursor to an elevated temperature, an elevated pressure, or both an elevated temperature and pressure so as to at least partially melt the binder, thereby forming one of the one or more foam cores; and
disposing the formed foam core into a respective one of the one or more cells.

Clause 83. The method of any clause or example herein, in particular, any one of Clauses 81-82, wherein the binder comprises thermoplastic or organic fibers.

Clause 84. The method of any clause or example herein, in particular, Clause 83, wherein the thermoplastic fibers comprise polyester.

Clause 85. The method of any clause or example herein, in particular, any one of Clauses 83-84, wherein a content of the thermoplastic fibers in the formed foam core is in a range of 5-15 wt %, inclusive.

Clause 86. The method of any clause or example herein, in particular, any one of Clauses 81-85, wherein the elevated temperature is at least 150° C., the elevated temperature is less than or equal to 250° C., the elevated pressure is at least 2 kPa, the elevated pressure is less than or equal to 1 MPa, or any combination of the foregoing.

Clause 87. The method of any clause or example herein, in particular, any one of Clauses 81-86, wherein the plant material comprises fibers having a first length, the binder comprises other fibers having a second length, and/or the second length is greater than the first length.

Clause 88. The method of any clause or example herein, in particular, any one of Clauses 54-87, wherein the providing of (a) further comprises:
mixing the piece of lignin-compromised plant material with a surfactant to form a foam precursor;
subjecting the foam precursor to an elevated temperature for a first time period so as to form one of the one or more foam cores; and
disposing the formed foam core into a respective one of the one or more cells.

Clause 89. The method of any clause or example herein, in particular, any one of Clauses 49-53, wherein the providing of (a) further comprises:
mixing the plant material with a surfactant to form a foam precursor;
subjecting the foam precursor to an elevated temperature for a first time period so as to form one of the one or more foam cores; and
disposing the formed foam core into a respective one of the one or more cells.

Clause 90. The method of any clause or example herein, in particular, any one of Clauses 88-89, wherein the surfactant comprises sodium dodecyl sulfate.

Clause 91. The method of any clause or example herein, in particular, any one of Clauses 88-90, wherein the elevated temperature is at least 50° C., the elevated temperature is less than or equal to 100° C., the first time period is at least 1 hour, the first time period is less than 24 hours, or any combination of the foregoing.

Clause 92. The method of any clause or example herein, in particular, any one of Clauses 88-91, wherein the providing of (a) further comprises mechanically or chemically splitting the plant material into fibrils prior to forming a foam precursor.

Clause 93. The method of any clause or example herein, in particular, any one of Clauses 88-92, wherein the plant material and surfactant are combined with microfibrillated cellulose to form the foam precursor.

Clause 94. The method of any clause or example herein, in particular, any one of Clauses 49-93, wherein one, some, or all of the one or more foam cores further comprises inorganic nanoparticles.

Clause 95. The method of any clause or example herein, in particular, Clause 94, wherein the inorganic nanoparticles comprise silica.

Clause 96. The method of any clause or example herein, in particular, any one of Clauses 49-95, further comprising, prior to (b):
forming a base layer of the enveloping structure via vacuum forming, cold forming, thermoforming, or any combination of the foregoing,
wherein the base layer comprises protruding portions that at least partly defines the one or more cells.

Clause 97. The method of any clause or example herein, in particular, any one of Clauses 49-96, wherein:
the enveloping structure comprises a base layer and a cap layer; and
the method further comprises, after (a) and prior to (b), disposing the cap layer over the base layer so as to enclose the one or more foam cores within the respective one or more cells.

Clause 98. The method of any clause or example herein, in particular, any one of Clauses 96-97, wherein (i) the base layer comprises a densified, lignin-compromised piece of wood or bamboo, (ii) the cap layer comprises a densified, lignin-compromised piece of wood or bamboo, or both (i) and (ii).

Clause 99. The method of any clause or example herein, in particular, any one of Clauses 96-98, wherein the enveloping structure further comprises a gas-barrier film enclosing the base layer, the cap layer, the one or more cells, and the one or more foam cores.

Clause 100. The method of any clause or example herein, in particular, any one of Clauses 49-99, wherein, prior to (b), a frame is disposed within the enveloping structure and at least partly defines the one or more cells.

Clause 101. The method of any clause or example herein, in particular, Clause 100, wherein the frame comprises a polymer.

Clause 102. The method of any clause or example herein, in particular, any one of Clauses 100-101, wherein the frame comprises a closed-cell foam.

Clause 103. The method of any clause or example herein, in particular, any one of Clauses 100-102, wherein the frame is composed of polyurethane or polyethylene.

Clause 104. The method of any clause or example herein, in particular, any one of Clauses 100-103, wherein the frame comprises a densified, lignin-compromised piece of wood or bamboo.

Clause 105. The method of any clause or example herein, in particular, any one of Clauses 100-104, further comprising, after (b), cutting the vacuum-insulated structure along a portion of the frame such that a foam core adjacent to the cut portion remains sealed.

Clause 106. The method of any clause or example herein, in particular, any one of Clauses 49-105, wherein, after (b), the pressure within one, some, or all of the one or more cells is less than or equal to 100 Pa.

Clause 107. The method of any clause or example herein, in particular, any one of Clauses 49-106, wherein, after (b), the pressure within one, some, or all of the one or more cells is about 10 Pa.

Clause 108. The method of any clause or example herein, in particular, any one of Clauses 49-107, wherein the plant material is wood or bamboo.

### CONCLUSION

Any of the features illustrated or described herein, for example, with respect to FIGS. 1A-7C and Clauses 1-108, can be combined with any other feature illustrated or described herein, for example, with respect to FIGS. 1A-7C and Clauses 1-108 to provide materials, systems, devices, structures, methods, and embodiments not otherwise illustrated or specifically described herein. All features described herein are independent of one another and, except where structurally impossible, can be used in combination with any other feature described herein. In view of the many possible embodiments to which the principles of the disclosed technology may be applied, it should be recognized that the illustrated embodiments are only examples and should not be taken as limiting the scope of the disclosed technology. Rather, the scope is defined by the following claims. We therefore claim all that comes within the scope and spirit of these claims.

1. A vacuum-insulated structure comprising:
one or more internal cells;
one or more foam cores, each foam core comprising a plant material and being disposed within a respective one of the one or more cells; and
an enveloping structure sealing each foam core within the respective cell at a pressure less than atmospheric pressure.

2. The vacuum-insulated structure of claim 1, wherein the enveloping structure comprises a base layer and a cap layer disposed over the base layer.

3-7. (canceled)

8. The vacuum-insulated structure of claim 1, further comprising a frame disposed within the enveloping structure and defining the one or more internal cells.

9. (canceled)

10. The vacuum-insulated structure of claim 8, wherein the frame comprises a closed-cell foam.

11. (canceled)

12. The vacuum-insulated structure of claim 8, wherein the frame comprises a densified, lignin-compromised piece of wood or bamboo.

13. (canceled)

14. The vacuum-insulated structure of claim 1, wherein:
the plant material in one, some, or all of the one or more foam cores comprises lignin-compromised plant material,
the lignin-compromised plant material comprises modified lignin therein, and
the modified lignin has shorter macromolecular chains than that of native lignin in the natural plant material.

15-18. (canceled)

19. The vacuum-insulated structure of claim 1, wherein:
the plant material in one, some, or all of the one or more foam cores comprises lignin-compromised plant material, and
the lignin-compromised plant material is at least partially delignified plant material.

20-27. (canceled)

28. The vacuum-insulated structure of claim 1, wherein:
one, some, or all of the one or more foam cores further comprises a binder, and
the binder comprises wood glue, epoxy, agar, 2-hydroxyethyl cellulose, carboxymethyl cellulose sodium salt, or any combination of the foregoing.

29-30. (canceled)

31. The vacuum-insulated structure of claim 1, wherein:
the plant material in one, some, or all of the foam cores comprises plant material fibers having a first length;
the one, some, or all of the one or more foam cores further comprise other fibers having a second length; and
the second length is greater than the first length.

32. (canceled)

33. The vacuum-insulated structure of claim 31, wherein the first length is less than or equal to 1 μm, the second length is less than or equal to 100 μm.

34-36. (canceled)

37. The vacuum-insulated structure of claim 1, wherein one, some, or all of the one or more foam cores further comprise a surfactant or residue of the surfactant.

38-43. (canceled)

44. The vacuum-insulated structure of claim 1, wherein the plant material is wood or bamboo.

45. A method comprising:
(a) providing one or more foam cores in one or more cells, each foam core comprising a plant material and being disposed within a respective one of the one or more cells; and
(b) sealing an enveloping structure under vacuum to form a vacuum-insulated structure and such that each foam core within the respective cell is sealed at a pressure less than atmospheric pressure.

46. The method of claim 45, wherein the providing of (a) comprises:
subjecting a piece of natural plant material having native lignin therein to a chemical treatment so as to compromise the native lignin, thereby forming a piece of lignin-compromised plant material.

47. The method of claim 46, wherein, after the subjecting, the piece of lignin-compromised plant material has modified lignin therein, and the modified lignin has shorter macromolecular chains than that of native lignin in the piece of natural plant material.

48-56. (canceled)

57. The method of claim 46, wherein, after the subjecting, the piece of lignin-compromised plant material is at least partially delignified plant material.

58-72. (canceled)

73. The method of claim 45, wherein:
the providing of (a) comprises:
mixing the plant material with a binder to form a foam precursor;
subjecting the foam precursor to an elevated temperature, an elevated pressure, or both an elevated temperature and pressure so as to at least partially melt the binder, thereby forming one of the one or more foam cores; and
disposing the formed foam core into a respective one of the one or more cells, and
the plant material comprises fibers having a first length, the binder comprises other fibers having a second length, and the second length is greater than the first length.

74-93. (canceled)

94. The method of claim 45, wherein:
prior to (b), a frame is disposed within the enveloping structure and at least partly defines the one or more cells, and
the frame comprises a closed-cell foam.

95. (canceled)

96. The method of claim 45, wherein;
prior to (b), a frame is disposed within the enveloping structure and at least partly defines the one or more cells, and
the frame comprises a densified, lignin-compromised piece of wood or bamboo.

97. The method of claim 45, wherein:
prior to (b), a frame is disposed within the enveloping structure and at least partly defines the one or more cells, and
the method further comprises, after (b), cutting the vacuum-insulated structure along a portion of the frame such that a foam core adjacent to the cut portion remains sealed.

98-100. (canceled)
